(19) United States
(12) Patent Application Publication
(10) Pub. No.: US 2016/0135242 A1
(43) Pub. Date: May 12, 2016

(54) OPPORTUNISTIC IOE MESSAGE DELIVERY VIA SENSOR-TRIGGERED FORWARDING

(71) Applicant: QUALCOMM Incorporated, San Diego, CA (US)

(72) Inventors: Karl Georg Hampel, New York, NY (US); Vincent Douglas Park, Budd Lake, NJ (US); Junyi Li, Chester, NJ (US)

(21) Appl. No.: 14/826,373

(22) Filed: Aug. 14, 2015

Related U.S. Application Data
(60) Provisional application No. 62/078,755, filed on Nov. 12, 2014.

(51) Int. Cl. H04W 76/02; H04W 8/00; H04W 40/02

(52) U.S. Cl. CPC H04W 76/023; H04W 40/02; H04W 8/005

(57) ABSTRACT

Opportunistic wide area network (WAN) connectivity for sensor devices with low transmit power, triggered by sensor device broadcasts, is disclosed which increases the likelihood of the sensor devices' data messages reaching the base station. Multiple sensor devices within proximity to each other establish device to device links. When a sensor device successfully connects to the base station, the base station informs the sensor device selected as a gateway, which in turn broadcasts its identification to peer sensor devices by way of a multi-hop rebroadcasting scheme. This triggers a multi-hop forwarding scheme where sensor devices that receive the broadcast forward their data messages via the D2D links to other peers until their data messages reach the gateway sensor device. The gateway sensor device forwards data messages it receives to the base station, so that the base station receives data packets from multiple sensor devices via the gateway sensor device.

### CROSS-REFERENCE TO RELATED APPLICATIONS

The present application claims the benefit of U.S. Provisional Patent Application No. 62/078,755, filed Nov. 12, 2014, and entitled “Opportunistic IOE Message Delivery via Sensor-Triggered Forwarding,” the disclosure of which is incorporated by reference herein in its entirety.

### TECHNICAL FIELD

This application relates to wireless communication systems, and more particularly to improving uplink communications from “internet of everything” (IOE) devices to base stations of a wide area network (WAN) through opportunistic forwarding of data messages to gateways identified in a message rebroadcasted from the gateways over links between IOE devices.

### BACKGROUND

Sensors that can link to other sensors and computer systems continue to be embedded with more and more devices or objects, resulting in the “internet of everything” (also referred to as the “internet of things”), using a variety of wired and/or wireless communication technologies. The growth in connectivity results in machine-to-machine (M2M) communication without human intervention. Some examples of integration include devices that integrate sensors or meters to capture information that is then relayed to a remote system, such as a central server. This can include smart metering, temperature monitoring, pressure monitoring, fluid flow monitoring, inventory monitoring, water level monitoring, equipment monitoring, healthcare monitoring, wildlife monitoring, weather and geological event monitoring, fleet management and tracking, remote security sensing, physical access control, transaction-based business charging, and other applications.

Given their nature, these sensors embedded with devices or objects are typically designed to consume low amounts of power and have low cost. For example, a sensor deployed in a gas meter (resulting in a “smart meter”) may be expected to last years without replacement or recharge (if recharging is possible). In contrast, a user equipment (UE), such as a mobile device, has significantly more transmit power that, together with other features of the given UE, consume enough power that the UE is expected to be recharged every few days, if not daily or more frequently. The sensors' limited transmit power (either by design or by choice), in contrast, impedes their ability to establish an uplink channel to a base station even when the base station has a clear downlink channel (due to the base station's greater transmit power).

These sensors are designed to periodically wake up to deliver their data to a central server. However, they cannot deliver their data unless they either wind up sufficiently close to a base station or opportunistically detect a UE to use as a relay to reach a base station. Either scenario has a limited likelihood of occurring during the specific wake up periods. As a result, there is a need for techniques to improve the likelihood of sensors being able to deliver their data to the network (e.g., to a central server) even when not within proximity of a base station or opportunistically near enough to a UE to function as a relay.

### SUMMARY

In an aspect of the disclosure, a method for communicating with a wireless network includes transmitting, from a first sensor, a connection request to a base station, receiving, at the first sensor, a message from the base station indicating that the first sensor is a gateway to the base station, transmitting, from the first sensor to a second sensor in communication with the first sensor, a signal indicating that the first sensor is the gateway, and relaying, via the first sensor, a data packet from the second sensor to the base station.

In an additional aspect of the disclosure, a method for communicating with a wireless network includes receiving, at a base station, a connection request from a first sensor, assigning, by the base station, the first sensor as a gateway in response to receiving the connection request, transmitting, from the base station, a message indicating that the first sensor is the gateway to the first sensor, wherein the first sensor broadcasts information to a second sensor in communication with the first sensor that indicates the first sensor is the gateway, and receiving, at the base station, a data packet from the second sensor, wherein the data packet from the second sensor is relayed to the base station via the first sensor.

In an additional aspect of the disclosure, a sensor apparatus includes a sensor configured to generate data from a detected event, a transceiver configured to: transmit a connection request to a base station, receive a message from the base station indicating that the sensor apparatus is a gateway to the base station, and transmit a signal indicating that the sensor apparatus is the gateway to a second sensor in communication with the sensor apparatus, and a forwarding module executed by a processor and configured to cause the transceiver to relay a data packet from the second sensor to the base station.

In an additional aspect of the disclosure, a base station for wireless communication includes a transceiver configured to receive a connection request from a first sensor, a processor configured to assign the first sensor as a gateway in response to receiving the connection request, and the transceiver further configured to: transmit a message indicating that the first sensor is the gateway to the first sensor, wherein the first sensor broadcasts information to a second sensor in communication with the first sensor that indicates the first sensor is the gateway, and receive a data packet from the second sensor, wherein the data packet from the second sensor is relayed to the base station via the first sensor.

### BRIEF DESCRIPTION OF THE DRAWINGS

FIG. 1 is a diagram of an exemplary wireless communications environment according to embodiments of the present disclosure.

FIG. 2 is a block diagram of an exemplary sensor device according to embodiments of the present disclosure.

FIG. 3 is a block diagram of an exemplary base station according to embodiments of the present disclosure.

FIG. 4 is a block diagram of an exemplary mobile relay device according to embodiments of the present disclosure.

FIG. 5 is a diagram of communications between devices in an exemplary wireless communications environment according to embodiments of the present disclosure.

FIG. 6 is a diagram of communications between devices in an exemplary wireless communications environment according to embodiments of the present disclosure.

FIG. 7 is a protocol diagram that illustrates example transmissions according to embodiments of the present disclosure.

FIG. 8 is a flowchart illustrating an exemplary method for receiving data messages via WAN-triggered forwarding according to embodiments of the present disclosure.

FIG. 9 is a flowchart illustrating an exemplary method for sending data messages via sensor-triggered forwarding according to embodiments of the present disclosure.

FIG. 10 is a flowchart illustrating an exemplary method for forwarding data messages via sensor-triggered forwarding according to embodiments of the present disclosure.

FIG. 11 is a flowchart illustrating an exemplary method for sending data messages via sensor-triggered forwarding according to embodiments of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies, such as a next generation (e.g., 5^{th} Generation (5G)) network.

Embodiments of the present disclosure introduce a systems and techniques to enhance the probability of the opportunistic event of WAN connectivity to occur. Sensor devices in sufficient vicinity to each other may establish device-to-device (D2D) links with each other. In doing so, the sensor devices may help each other by mutually forwarding their data messages via the D2D links toward a sensor device that has attained WAN connectivity. For this purpose, each sensor device broadcasts its own message and re-broadcasts messages it receives from peers in a multi-hop manner. The rebroadcast scheme can be based on flooding or it may adhere to a routing scheme that sensors may have established over time due to a listening and learning procedure, for instance.

This multi-hop forwarding scheme can be initiated reactively as soon as (at least) one sensor device successfully connects to a base station. The forwarding scheme may be triggered by a broadcast from the selected gateway sensor. The broadcast from the selected gateway sensor is rebroadcasted among the other sensor devices using a multi-hop rebroadcasting scheme. This rebroadcasting of the gateway's broadcast may additionally serve to define a reverse path for the various sensor devices back to the gateway sensor device for transmission of data messages. The sensor devices transmit their data messages towards the gateway device, for example using as their routes the reverse paths of the rebroadcasted gateway broadcast. The gateway sensor device forwards data messages it receives from its peers via the D2D links to the base station. The base station may then send an acknowledgement for data message reception to the sensors via a broadcast message. In this manner, the likelihood of each sensor device's data having its data reach the base station is substantially increased.

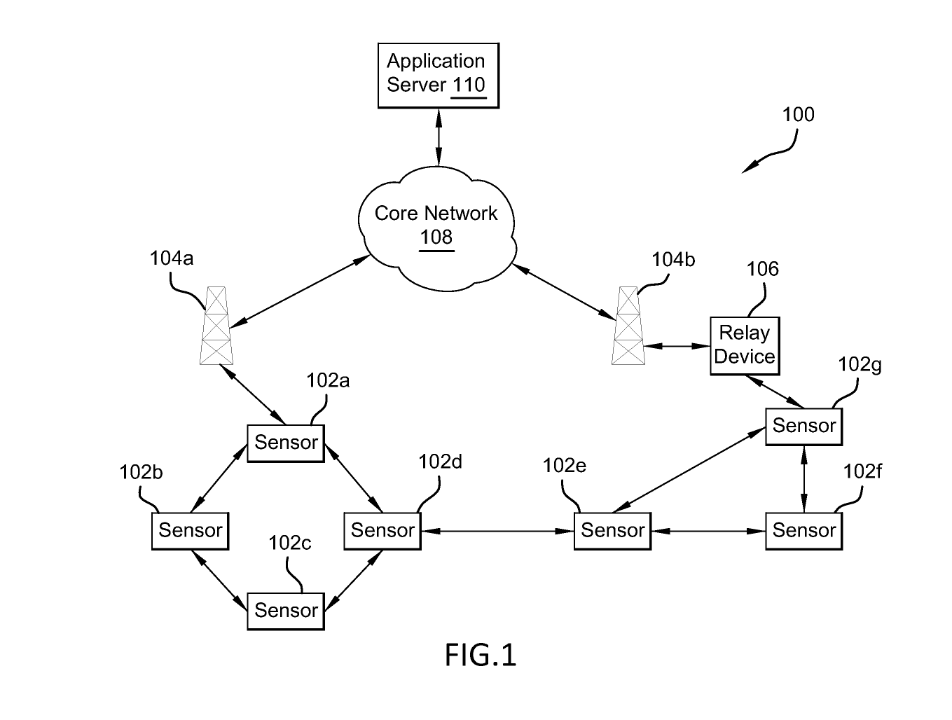

FIG. 1 is a diagram of an exemplary wireless communications environment 100 according to embodiments of the present disclosure. The communications environment 100 may include a number of sensor devices 102a-102g, a number of base stations 104a-104b, a number of relay devices 106, a core network 108, and one or more application servers 110.

The communications environment 100 may support operation on multiple carriers (e.g., waveform signals of different frequencies). Multi-carrier transmitters can transmit modulated signals simultaneously on the multiple carriers. For example, each modulated signal may be a multi-carrier channel modulated according to the various radio technologies described above. Each modulated signal may be sent on a different carrier and may carry control information (e.g., pilot signals, control channels, etc.), overhead information, data, etc. The communications environment 100 may be a multi-carrier LTE network capable of efficiently allocating network resources. The communications environment 100 is one example of a network to which various aspects of the disclosure apply.

One or both of the base stations 104 may include an evolved Node B (eNodeB), for example. A base station 104 may also be referred to as a base transceiver station or an access point. FIG. 1 illustrates two base stations, 104a and 104b, for purposes of simplicity only. It will be recognized that there could be one to many base stations, as well as be an assortment of different types such as macro, pico, and/or femto base stations. The base stations 104 may communicate with the application server 110 via a backhaul such as core network 108. The base stations 104 may also communicate with one another directly or indirectly, such as via core network 108.

The sensor devices 102 may be dispersed throughout the communications environment 100, and each sensor device 102 may be stationary or mobile. FIG. 1 illustrates sensor devices 102a-102g for purposes of simplicity of illustration only. More or fewer may be deployed within the communications environment 100 as will be understood to those skilled in the relevant art(s). Sensor devices 102a-102g may either be stand-alone or integrated within other devices. The sensor devices 102 may capture information that is then relayed to a remote system, such as application server 110 in FIG. 1. Sensor devices 102 may have limited power resources because they are integrated with devices or objects, such as to render those devices or objects “smart,” and need to be able to operate for long periods of time without replacement or recharge, e.g. days, weeks, months, or years. As a result, the sensor devices 102 may synchronize with a beacon that the base stations 104 emit. As a result of this synchronization, each of the sensor devices 102 may only awake at predefined time intervals according to the beacon in order to decrease power consumption.

Sensor devices 102 can be capable of linking to each other, for example via D2D links. In an embodiment, the sensor devices 102 link to each other by sending out discovery messages to determine what other sensor devices 102 may be within a neighboring vicinity. Each of the sensor devices 102 may maintain its own routing table, for example as established over time based on a listening and learning procedure. In an embodiment, the routing tables may be populated and/or updated whenever a gateway sensor device broadcasts its functionality to its peers via D2D links and a multi-hop rebroadcasting scheme. Discovery may occur periodically or when a sensor device 102 is first added to the communications environment 100. As just one example, for purposes of discussion assuming sensor device 102c is newly added to the communications environment 100, sensor device 102c may send out a discovery message to locate any other sensor devices 102 that may be within sufficient proximity to respond. Here, sensor devices 102b and 102d may respond, thereby establishing a D2D link between sensor devices 102c and 102b and between sensor devices 102c and 102d. Alternatively, one or both of sensor devices 102b and 102d may periodically send out a discovery message and discovery sensor device 102c when it is newly in proximity, and links may thereby be established.

The relay device 106 is representative of one or more relay devices 106 that may be dispersed throughout the wireless network 100 and can be either stationary or mobile. A single relay device 106 is shown for purposes of simplicity. The relay device 106, for example a UE, may also be referred to as a terminal, a mobile station, a subscriber unit, etc. A relay device 106 may be a cellular phone, a smartphone, a personal digital assistant, a wireless modem, a laptop computer, a tablet computer, etc.

The application server 110 may be a central server that the sensor devices 102 are attempting to transmit data to for storage and/or analysis. The application server 110 may receive data as it is conveyed from the base stations 104 from one or more of the sensor devices 102 and make use of information from the data and/or present it to one or more users that interact with the application server 110.

In an embodiment, each of the base stations 104a and 104b may have a sufficiently large coverage area that the sensor devices 102a-102g each can receive data, for example sensor devices 102a-102d from base station 104a and sensor devices 102e-102g from base station 104b, via a downlink. The downlink (or forward link) refers to the communication link from a base station 104 to a relay device 106 and/or the sensor devices 102. Although capable of establishing a downlink with base stations 104, in embodiments of the present disclosure one or more of the sensor devices 102 may not have sufficient power to be able to establish an uplink to their respective base station 104. The uplink (or reverse link) refers to the communication link from a sensor device 102 or a relay device 106 to a base station 104.

In the example depicted in FIG. 1, among sensor devices 102a-102d, sensor device 102a is in sufficient proximity to the base station 104a to be able to establish an uplink directly. The other sensor devices 102b-102d that fall within the coverage area of the base station 104a may not be able to establish an uplink for one or more of the reasons given above (e.g., insufficient power resources or as set by policy in order to assure a long operating life). According to embodiments of the present disclosure, in view of the connection between base station 104a and sensor device 102a, the base station 104a may designate sensor device 102a as a gateway for the other sensor devices within downlink range of the base station (here, sensor devices 102a-102d) and convey this information to the sensor device 102a for broadcasting to peer sensor devices 102.

In response, any of the sensor devices 102b-102d that have data to send, e.g. to the application server 110, may forward their data messages to one or more neighboring sensor devices 102 via respective D2D links. The sensor devices 102b-102d may also rebroadcast any data messages received from neighboring sensor devices in a multi-hop manner, for example either based on a flooding scheme or a routing scheme established over time and as indicated in a routing table in each sensor device 102. In this way, data messages from the sensor devices 102b-102d, that cannot establish direct uplinks with the base station 104a, may still transmit their respective data messages to the base station 104a (and on to application server 110 via the core network 108) via the sensor device 102a that is operating as a gateway.

Further with respect to the example depicted in FIG. 1, none of the sensor devices 102e-102g may be within uplink range of the base station 104b, though they all may be within downlink range. In such scenarios, according to embodiments of the present disclosure, the relay device 106 may provide an opportunistic relay between the sensor device 102g and the base station 104b as illustrated in FIG. 1. This may be advantageous, for example, where the sensor device 102g is not able to effectively and/or timely communicate data to the base station 104b. When the relay device 106 moves into a position in close enough proximity to the sensor device 102g that the two may communicate, the relay device 106 may receive and forward data messages from the sensor device 102g to the base station 104b.

Where the sensor device 102g is able to establish an uplink with the base station 104b via the relay device 106, the base station 104b may designate the sensor device 102g as a gateway for other sensor devices within downlink range of the base station (e.g., sensor devices 102e and 102f in FIG. 1). The base station 104b may convey this information to the sensor device 102g. The sensor device 102g may then broadcast identifying information that indicates the sensor device 102g is a gateway to its peer sensor devices 102 using a multi-hop rebroadcasting scheme. In response, any of the sensor devices that have data to send may send their data messages toward the sensor device 102g operating as gateway via respective D2D links. Where there are intervening neighbors between the originating sensor device 102 and the gateway sensor device 102g, the intervening neighbor sensor device(s) 102 may rebroadcast the data messages they receive on toward the gateway sensor device 102g in a multi-hop manner. In this way, data messages from the sensor devices that cannot establish direct uplinks (or uplinks via a relay device 106) with the base station 104b may still transmit their respective data messages to the base station 104b (and on to application server 110 via the core network 108) via the gateway sensor device 102g and relay device 106.

In an embodiment, there may be multiple sensor devices 102 that are able to establish direct uplinks (or via one or more relay devices 106) to the base station 104. When this happens, the base station 104 may analyze information received, derived, or determined from one or more messages from the multiple sensor devices 102 to determine whether to select a subset as gateways. For example, where two sensor devices 102 are able to establish an uplink with the base station 104a, the base station 104a may analyze the information and select the sensor device 102 with the better link quality to be a designated gateway. Other exemplary metrics may be used instead of, or in cooperation with, link quality as will be recognized by those skilled in the relevant art(s). In an embodiment, the sensor devices 102 re-attempt to connect to a base station at each interval (as synchronized with a beacon). Alternatively, the sensor device(s) 102 selected as gateways in prior time intervals may continue to operate as gateways until a new broadcast from a new gateway sensor device 102 is received that indicates another sensor device(s) 102 has been selected, or the gateway sensor device 102 is unable to successfully re-establish an uplink to the base station 104. Further, the amount of time a particular sensor device 102 can serve as a gateway may be limited by the sensor device 102 and/or the base station 104 in order to conserve power of the sensor device 102 that may be increased when acting as a gateway for other sensor devices.

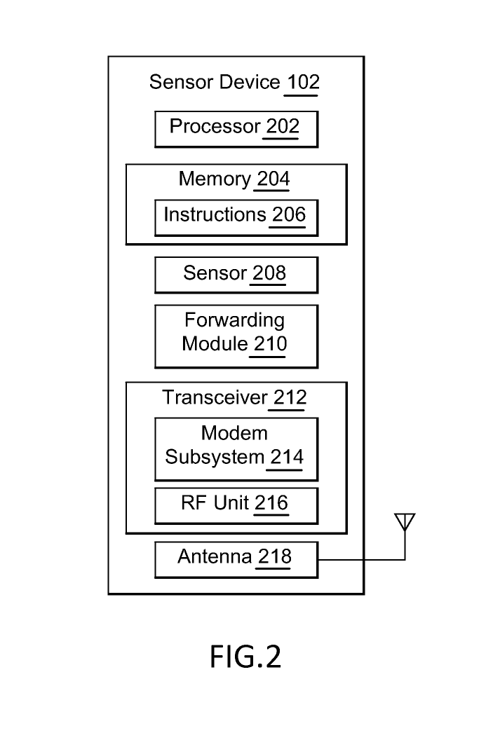

FIG. 2 is a block diagram of an exemplary sensor device 102 according to embodiments of the present disclosure. The sensor device 102 may have any one of many configurations for various IOE applications described above. The sensor device 102 may include a processor 202, a memory 204, a sensor 208, a forwarding module 210, a transceiver 212, and an antenna 218. These elements may be in direct or indirect communication with each other, for example via one or more buses.

The processor 202 may include a central processing unit (CPU), a digital signal processor (DSP), an application-specific integrated circuit (ASIC), a controller, a field programmable gate array (FPGA) device, another hardware device, a firmware device, or any combination thereof configured to perform the operations described herein with reference to the sensor devices 102 introduced above with respect to FIG. 1 and discussed in more detail below. The processor 202 may also be implemented as a combination of computing devices, e.g., a combination of a DSP and a microprocessor, a plurality of microprocessors, one or more microprocessors in conjunction with a DSP core, or any other such configuration.

The memory 204 may include a cache memory (e.g., a cache memory of the processor 442), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 204 includes a non-transitory computer-readable medium. The memory 204 may store instructions 206. The instructions 206 may include instructions that, when executed by the processor 202, cause the processor 202 to perform the operations described herein with reference to the sensor device 102 in connection with embodiments of the present disclosure. Instructions 206 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sensor 208 may be any sensor or meter capable of perceiving and capturing information about some aspect of its environment. This could include service metering (e.g., for gas utilities), temperature monitoring, pressure monitoring, fluid flow monitoring, inventory level monitoring, water level monitoring, equipment status monitoring, wildlife tracking, weather event monitoring, geological event monitoring, fleet tracking, and transaction-based business charging, to name just a few examples. Sensor 208 may send any information it captures as data to the transceiver 212 for opportunistic transmission to a remote site, such as application server 110. Sensor 208 may also send any information it captures as data to the memory 204 for temporary or permanent storage.

The forwarding module 210 may be used to determine what time slots the sensor device 102 will use for sending its own data messages as well as other acts of communication between other sensor devices 102. The forwarding module 210 may analyze data messages received from other sensor devices 102 in order to determine whether the data messages should be forwarded on or not. In embodiments where the sensor device 102 is selected as a gateway, the forwarding module 210 may guide the sensor device 102 in monitoring for incoming messages from other sensor devices 102. When incoming messages are received, the forwarding module 210 may also filter the received data messages to determine whether they should be forwarded on to a base station 104. The filtering may look at an authenticator, a hop count, a time stamp, or any combination to name a few examples, to determine whether the data message should be forwarded on. In embodiments where the sensor device 102 is not selected as a gateway, the forwarding module 210 also filters any incoming data messages that are directed toward a gateway. In a non-selected sensor device 102, the forwarding module 210 may also check a routing table for an identifier of the gateway that a received data message is directed towards. If the routing table does not have an identifier, the forwarding module 210 may cause the sensor device 102 to drop the data message. Otherwise, the forwarding module 210 may use the routing table to direct the transceiver 212 on where the data message should be forwarded to.

The transceiver 212 may include a modem subsystem 214 and a radio frequency (RF) unit 216. The transceiver 212 is configured to communicate bi-directionally with other devices, such as base stations 104 and/or a relay device 106 (e.g., a UE). The modem subsystem 214 may be configured to modulate and/or encode the data from the sensor 208 and/or the forwarding module 210 according to a modulation and coding scheme (MCS), e.g., a low-density parity check (LDPC) coding scheme, a turbo coding scheme, a convolutional coding scheme, etc. The RF unit 216 may be configured to process (e.g., perform analog to digital conversion or digital to analog conversion, etc.) modulated/encoded data from the modem subsystem 214 (on outbound transmissions) or of transmissions originating from another source such as a base station 104 or a relay device 106. Although shown as integrated together in transceiver 212, the modem subsystem 214 and the RF unit 216 may be separate devices that are coupled together at the sensor device 102 to enable the sensor device 102 to communicate with other devices.

The RF unit 216 may provide the modulated and/or processed data, e.g. data packets (or, more generally, data messages which may contain one or more data packets and other information), to the antenna 218 for transmission to one or more other devices. This may include, for example, transmission of data messages to another sensor device 102 via a D2D link, to a relay device 106 for relay to a base station 104, or to a base station 104, according to embodiments of the present disclosure. The antenna 218 may further receive data messages transmitted from a base station 104, relay device 106, and/or other sensor device 102 and provide the received data messages for processing and/or demodulation at the transceiver 212. Although FIG. 2 illustrates antenna 218 as a single antenna, antenna 216 may include multiple antennas of similar or different designs in order to sustain multiple transmission links.

Any given sensor device 102 may serve a different role at different times. If the sensor device 102 is in sufficient proximity to a base station 104, or happens to be proximate to a relay device 106 for a period of time, it may be selected by the base station 104 it communicates with to be a gateway for other sensor devices 102 that it has D2D links with. At other times, the sensor device 102 may rely on another sensor device 102 that has been designated as a gateway, whether the designated sensor device 102 is a direct neighbor or a series of hops away via D2D links.

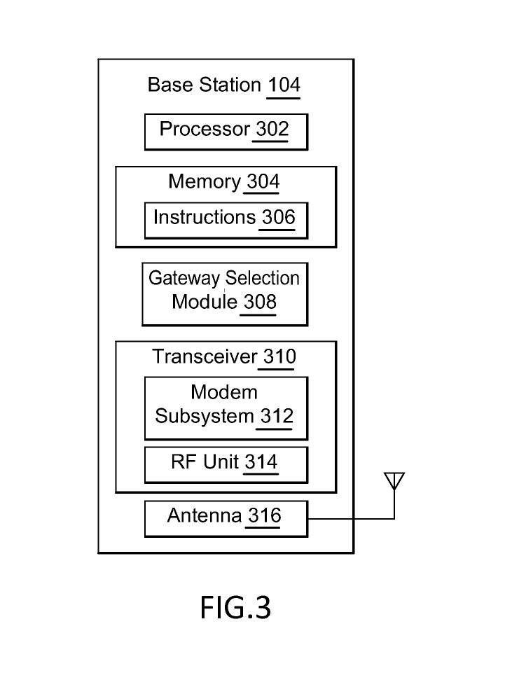

FIG. 3 is a block diagram of an exemplary base station 104 according to embodiments of the present disclosure. The base station 104 may include a processor 302, a memory 304, a gateway selection module 308, a transceiver 310, and an antenna 316. These elements may be in direct or indirect communication with each other, for example via one or more buses. The base station 104 may be an evolved Node B (eNodeB), a macro cell, a pico cell, a femto cell, a relay station, an access point, or another electronic device operable to perform the operations described herein with respect to the base station 104. The base station 104 may operate in accordance with one or more communication standards, such as a 3rd generation (3G) wireless communication standard, a 4th generation (4G) wireless communication standard, a long term evolution (LTE) wireless communication standard, an LTE-advanced wireless communication standard, or another wireless communication standard now known or later developed (e.g., a next generation network operating according to a 5G protocol).

The processor 302 may include a CPU, a DSP, an ASIC, a controller, a FPGA device, another hardware device, a firmware device, or any combination thereof configured to perform the operations described herein with reference to the base station 104 introduced in FIG. 1 above. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), RAM, MRAM, ROM, PROM, EPROM, EEPROM, flash memory, a solid state memory device, one or more hard disk drives, other forms of volatile and non-volatile memory, or a combination of different types of memory. In an embodiment, the memory 304 includes a non-transitory computer-readable medium. The memory 304 may store instructions 306. The instructions 306 may include instructions that, when executed by the processor 302, cause the processor 302 to perform the operations described herein with reference to the base station 104 in connection with embodiments of the present disclosure. Instructions 306 may also be referred to as code, which may be interpreted broadly to include any type of computer-readable statement(s) as discussed above with respect to FIG. 2.

The gateway selection module 308 may operate to select one or more sensor devices 102 that were successful in establishing an uplink with the base station 104 as gateways for other sensor devices 102. In an embodiment, the gateway selection module 308 analyzes one or more metrics of a connection of the successful sensor device 102 to determine whether to select the successful sensor device 102 as a gateway. Some examples of metrics include link quality and information about the connectivity of the successful sensor device 102 to other sensor devices 102 via D2D links, to name just a couple. In an embodiment, the base station 104 receives the metrics, such as link quality, from the successful sensor device 102. Alternatively, the base station 104 may itself measure link quality or other metrics that are then used by the gateway selection module 308 for gateway selection.

The gateway selection module 308 may analyze the metrics in order to determine whether to select a successful sensor device 102 as a gateway. For example, where there are multiple sensor devices 102 that were successful in connecting with a base station 104 and that have D2D links to one or more common sensor devices 102, the gateway selection module 308 may analyze the link quality of each successful sensor device 102 and select a subset from those sensor devices 102, e.g. one, two, or more, to function as gateways for the other sensor devices 102. Continuing with this example, if a particular sensor device 102 was successful but not selected as a gateway, it may operate in a non-gateway fashion and forward its data packets to a designated gateway sensor device 102.

Once the gateway selection module 308 has selected one or more gateways, the gateway selection module 308 may pass on identifying information of the selected sensor device(s) 102 to the transceiver 310 so that the information may be sent to the selected sensor device 102 so that the selected sensor device 102 may broadcast its identification as a gateway to its peer devices, for example by way of a multi-hop rebroadcasting scheme. The transceiver 310 may include a modem subsystem 312 and a radio frequency (RF) unit 314. The transceiver 310 is configured to communicate bi-directionally with other devices, such as sensor devices 102 and/or a relay device 106. The modem subsystem 312 may be configured to modulate and/or encode data according to a MCS, some examples of which having been listed above with respect to FIG. 2. The RF unit 314 may be configured to process (e.g., perform analog to digital conversion or digital to analog conversion, etc.) of modulated/encoded data from the modem subsystem 312 (on outbound transmissions) or of transmissions originating from another source such as a sensor device 102 or a relay device 106. Although shown as integrated together in transceiver 310, the modem subsystem 312 and the RF unit 314 may be separate devices that are coupled together at the base station 104 to enable the base station 104 to communicate with other devices.

The RF unit 314 may provide the modulated and/or processed data, e.g. data packets, to the antenna 316 for transmission to one or more other devices such as sensor devices 102 and the relay device 106. After the transceiver 310 receives the identifying information from the gateway selection module 308, the modem subsystem 312 may modulate and/or encode the identifying information in preparation for transmission. The RF unit 314 may receive the modulated and/or encoded data packet and process the data packet prior to passing it on to the antenna 316. This may include, for example, transmission of data messages to one or more sensor devices 102 within downlink range, to a relay device 106 for relay to a sensor device 102, or to another base station 104, according to embodiments of the present disclosure. The antenna 316 may further receive data messages transmitted from a sensor device 102 and/or relay device 106, and provide the received data messages for processing and/or demodulation at the transceiver 310. Although FIG. 3 illustrates antenna 316 as a single antenna, antenna 316 may include multiple antennas of similar or different designs in order to sustain multiple transmission links.

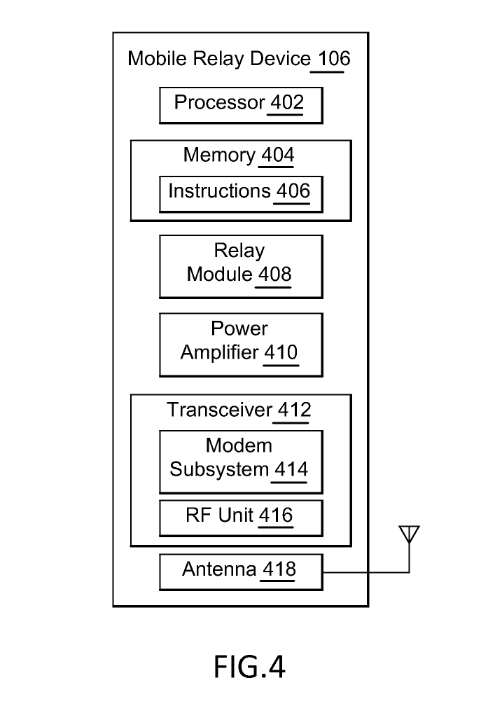

FIG. 4 is a block diagram of an exemplary mobile relay device 106 according to embodiments of the present disclosure. The relay device 106 may be a UE such as a mobile communication device (e.g., a smartphone, a cellular telephone, a personal digital assistant, etc.), a tablet computing device, a laptop computing device, a vehicle, a gaming console, a machine, a personal computing device, an e-reader device, a sensor device, another electronic device, or a combination of these devices, to name a few examples, that is operable to perform the operations described herein with respect to the relay device 106. The relay device 106 may include a processor 402, a memory 404, a relay module 408, a power amplifier 410, a transceiver 412, and an antenna 418. These elements may be in direct or indirect communication with each other, for example via one or more buses.

The processor 402 may include a CPU, a DSP, an ASIC, a controller, a FPGA device, another hardware device, a firmware device, or any combination thereof configured to perform the operations described herein with reference to the relay device 106 introduced in FIG. 1 above. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 302), RAM, MRAM, ROM, PROM, EPROM, EEPROM, flash memory, a solid state memory device, one or more hard disk drives, other forms of volatile and non-volatile memory, or a combination of different types of memory. In an embodiment, the memory 404 includes a non-transitory computer readable medium. The memory 404 may store instructions 406. The instructions 406 may include instructions that, when executed by the processor 402, cause the processor 402 to perform the operations described herein with reference to the relay device 106 in connection with embodiments of the present disclosure. Instructions 406 may also be referred to as code, which may be interpreted broadly to include any type of computer-readable statement(s) as discussed above with respect to FIG. 2.

The relay module 408 may operate to cause the relay device 106 to receive uplink data messages from a sensor device 102 and relay the data messages with an amplified signal to a base station 104 that the sensor device 102 would otherwise be unable to reach with an uplink. The relay module 408 may additionally enable the relay device 106 to relay downlink data messages from the base station 104 to the sensor device 102. In an embodiment, the base station 104 may transmit downlink data messages directly to a sensor device 102 due to the additional transmit power of the base station 104.

The power amplifier 410 may allow the relay device 106 to communicate over long distances, for example with one or multiple base stations 104. The power amplifier 410 may operate in cooperation with the transceiver 412 and the antenna 418 to amplify signals (containing data messages) that the antenna 418 will transmit to other devices, such as base stations 104 or sensor devices 102.

The transceiver 412 may include a modem subsystem 414 and a radio frequency (RF) unit 416. The transceiver 412 is configured to communicate bi-directionally with other devices, such as sensor devices 102 and/or base stations 104. The modem subsystem 414 may be configured to modulate and/or encode data according to a MCS, some examples of which having been listed above with respect to FIG. 2. The RF unit 416 may be configured to process (e.g., perform analog to digital conversion or digital to analog conversion, etc.) modulated/encoded data from the modem subsystem 414 (on outbound transmissions) or of transmissions originating from another source such as a sensor device 102 or a base station 104. Although shown as integrated together in transceiver 412, the modem subsystem 414 and the RF unit 416 may be separate devices that are coupled together at the relay device 106 to enable the relay device 106 to communicate with other devices.

The RF unit 416 may provide the modulated and/or processed data, e.g. data messages, to the antenna 418 for transmission to one or more other devices such as sensor devices 102 and base stations 104. After the transceiver 412 receives a data message for transmission, the modem subsystem 414 may modulate and/or encode the data message in preparation for transmission. The RF unit 416 may receive the modulated and/or encoded data message and process the data message prior to passing it on to the antenna 418. The antenna 418 may further receive data messages transmitted from sensor device 102 and/or base stations 104, and provide the received data messages for processing and/or demodulation at the transceiver 412. Although FIG. 4 illustrates antenna 418 as a single antenna, antenna 418 may include multiple antennas of similar or different designs in order to sustain multiple transmission links.

In an embodiment, the relay module 408 may cause the relay device 106 to initiate a discovery procedure to discover any sensor devices 102 that may be nearby and have data packets waiting to be transmitted to a base station 104. The relay module 408 may do so by broadcasting a peer discovery signal via the antenna 418 to indicate availability to serve as a relay to sensor devices 102. When a sensor device 102 responds, the relay module 408 may proceed with setting up a relay connection to the responding sensor device 102 and relaying data messages between a base station 104 and the sensor device 102. In an alternative embodiment or in addition, the relay device 106 may respond to a discovery signal transmitted from a requesting sensor device 102 and proceed with setting up the relay connection. Establishing an opportunistic relay connection can be performed as described in U.S. patent application Ser. No. 14/107,195 (filed Dec. 16, 2013) and U.S. patent application Ser. No. 14/107,221 (filed Dec. 16, 2013), each of which is incorporated by reference in its entirety.

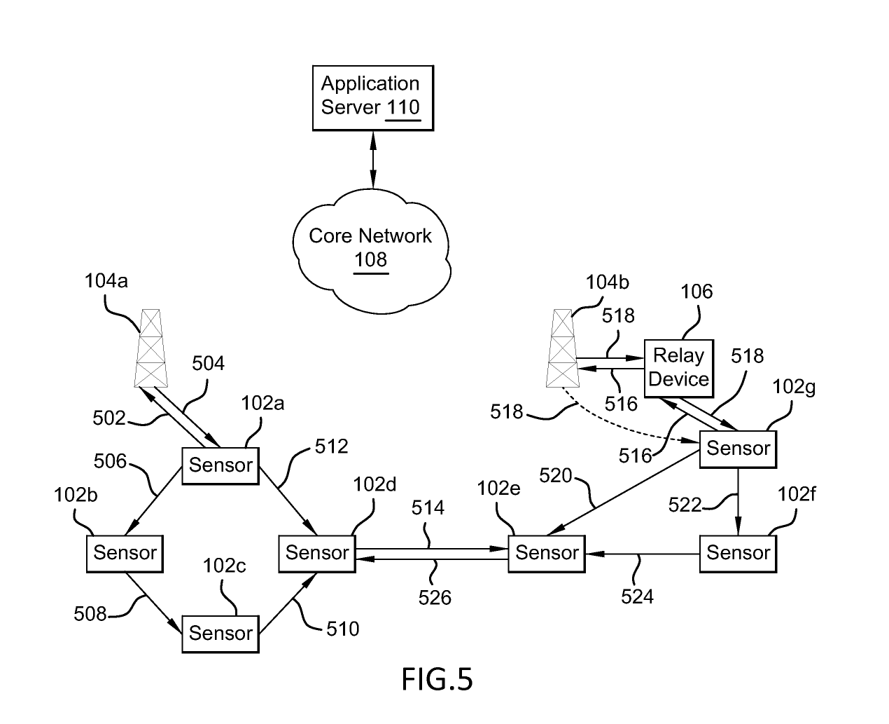

FIG. 5 is a diagram of communications between devices in the exemplary wireless communications environment 100 according to embodiments of the present disclosure. The sensor devices 102 attempt to establish an uplink with base stations 104. This may occur, for example, during a first time slot in a wake-up period that has been synchronized to a beacon transmitted from the base stations 104. A wake-up period may include a plurality of time slots that are used to implement various aspects of the present disclosure. Assigning these time slots with sufficiently small duty cycle may reduce the power consumption of the sensor devices 102, which may assist in prolonging the life of the sensor devices 102. In an embodiment, the base stations 104 may allocate the time slots via the beacons they transmit. Alternatively, the sensor devices 102 may cooperate together to allocate the time slots.

In FIG. 5, sensor device 102a is able to establish an uplink 502 to base station 104a and the base station 104a. In response, the base station 104a confirms the uplink 502 via downlink 504. Further in FIG. 5, although the sensor device 102g is unable to establish an uplink directly with a base station 104, the sensor device 102g is able to establish an uplink 516 to the base station 104b via a relay device 106. In response, the base station 104b confirms the uplink 516 via downlink 518. The downlink 518 from base station 104b to the sensor device 102g may be direct between the base station 104b and the sensor device 102g, or relayed via the relay device 106. Both options are illustrated in FIG. 5.

As one example, after successfully connecting to the base station 104a, the sensor device 102a may establish a traffic connection via the uplink 502 and transmit its own data message to the base station 104a. This may occur as part of the first time slot or a separate time slot in embodiments where time slots are used. Together with its own data message, or in a separate message, the sensor device 102a may send additional information related to link quality of the uplink 502 to the base station 104a, as well as information about connectivity of the sensor device 102a to other sensor devices 102, for example via D2D links. The base station 104a transmits an acknowledgment of receipt of the data message back to the sending device, sensor device 102a.

With the information received from the sensor device 102a, and/or generated on its own, the base station 104a may then decide whether to designate the sensor device 102a as a gateway for delivering data packets from other sensor devices 102 that were unable to establish an uplink with the base station 104a. In an embodiment where the sensor device 102a was the only sensor device successful in connecting with the base station 104a, the base station 104a might still decide not to designate the sensor 102a as a gateway, for example due to poor link quality or other factor that would impede the successful relaying of data packets from other sensor devices 102. If the link quality of uplink 502 is sufficient, however, the base station 104a may designate the sensor device 102a as a gateway. In another embodiment, several different sensor devices 102 may have established an uplink to the base station 104a with varying degrees of success. If so, the base station 104a may then analyze information received from the successful sensor devices 102 and/or generated on its own to select one or more sensor devices to be gateways. For example, the base station 104a may select the sensor device 102 with the best link quality, or some other metric.

Turning again to the example shown in FIG. 5, once the base station 104a has determined to designate a sensor device 102 that successfully established an uplink as a gateway, the base station 104a transmits the decision to the sensor device 102a via the downlink 504.

Once the sensor device 102a has received the decision, the sensor device 102a in turn may broadcast this information to its peer devices, for example by way of a multi-hop rebroadcasting scheme. The broadcast may identify the sensor device selected as a gateway, in the example of FIG. 5 sensor device 102a, such as by listing the sensor ID of sensor device 102a. In the example shown in FIG. 5, the sensor device 102a broadcasts its identifying information as gateway to its neighbors, sensor devices 102b and 102d via broadcasts 506 and 512 respectively. Sensor devices 102b and 102d, in turn, rebroadcast the information. For example, sensor device 102b rebroadcasts the information to the sensor device 102c as broadcast 508. Sensor device 102c rebroadcasts the information to the sensor device 102d as broadcast 510. Sensor device 102d rebroadcasts the information to the sensor device 102e as broadcast 514. Although not shown, the sensor device 102d may additionally rebroadcast the information to sensor device 102c. As can be seen, therefore, the information broadcasted from the gateway sensor device 102a may flood the linked network of peer sensor devices 102, resulting in a multi-hop rebroadcasting scheme.

The multi-hop rebroadcasting may occur in its own dedicated time slot so that the sensor devices 102 will know to listen at the appropriate time. The remaining sensor devices 102 that were unsuccessful in establishing an uplink listen for this broadcast and, when received, the broadcast from the sensor device 102a triggers a multi-hop forwarding scheme so that data messages can reach the gateway sensor device 102a for transmission to the base station 104a.

As another example, after successfully connecting to the base station 104b via the relay device 106, the sensor device 102g may establish a traffic connection via the uplink 516 and transmit its own data message to the base station 104b. Together with its own data message, or in a separate message, the sensor device 102g may send additional information related to link quality of the uplink 516 to the base station 104b, as well as information about connectivity of the sensor device 102g to other sensor devices 102, for example via D2D links. The base station 104b transmits an acknowledgment of receipt of the data message back to the sending device, sensor device 102g.

With the information received from the sensor device 102g, and/or generated on its own, the base station 104b may then decide whether to designate the sensor device 102g as a gateway for delivering data packets from other sensor devices 102, as discussed above with respect to the relationship between base station 104a and sensor device 102a.

Once the base station 104b has determined to designate a sensor device 102 as a gateway, the base station 104b transmits the decision 518 to the selected sensor device 102. As shown in FIG. 5, the decision 518 can be transmitted directly to sensor device 102g by the base station 104b or indirectly through relay device 106. For example, the base station 104b can transmit the decision 518 in a broadcast. The broadcast may occur in its own dedicated time slot so that the sensor device 102g will know to listen for the broadcast at the appropriate time. In that regard, despite being unable to establish a direct uplink to the base station 104b, the sensor device 102g may still be within a downlink range of the base station 104b due to the increased transmit power of the base station 104b relative to the limited power of the sensor device 102g. As another example, the base station 104b can transmit the decision 518 in a broadcast or other communication to the relay device 106, which then transmits the decision 518 on to the sensor device 102g. This relay approach may be particularly useful when the sensor device 102g is not within downlink range of the base station 104b and/or when a connection quality of the downlink is poor.

Once the selected sensor device 102, (sensor device 102g in FIG. 5) receives the decision, the sensor device may in turn broadcast this information to its peer devices, for example by way of a multi-hop rebroadcasting scheme. The broadcast may identify the selected device, in the example of FIG. 5 sensor device 102g, as a gateway such as by listing the sensor ID of sensor device 102g. In the example shown in FIG. 5, the sensor device 102g broadcasts its identifying information as gateway to its neighbors, sensor devices 102e and 102f, via broadcasts 520 and 522 respectively. Sensor devices 102e and 102f, in turn, rebroadcast the information. For example, sensor device 102e rebroadcasts the information to the sensor device 102d as broadcast 526, while sensor device 102f rebroadcasts the information to the sensor device 102e as broadcast 524. Although not shown, the sensor device 102e may additionally rebroadcast the information to sensor device 102f. As can be seen, therefore, the information broadcasted from the gateway sensor device 102g may flood the linked network of peer sensor devices 102, resulting in a multi-hop rebroadcasting scheme.

The multi-hop rebroadcasting may occur in its own dedicated time slot so that the sensor devices 102 will know to listen at the appropriate time. The remaining sensor devices 102 that were unsuccessful listen for this broadcast. When received, the broadcast from the sensor device 102g triggers a multi-hop forwarding scheme so that data packets can reach the gateway sensor device 102g for transmission to the base station 104b.

Although not shown, the broadcast 526 received by sensor device 102d that identifies the sensor device 102g as a gateway may be forwarded throughout the sensor devices 102a-102d as well, though those devices may be within the downlink coverage area of the base station 104a. Similarly, although not shown the broadcast 514 received by sensor device 102e that identifies the sensor device 102a as a gateway may be forwarded throughout the sensor devices 102e-102g as well, though those devices may be within the downlink coverage area of the base station 104b and not 104a. As such, it may be an option for the sensor devices 102b-102d to forward data messages to the gateway 102g, and the sensor devices 102e-102f to forward data messages to the gateway 102a. Other factors, such as max hop counts, time stamps, and other factors may steer these different sensor devices 102 to first attempt to transmit their data messages to the gateway to the base station 104 to which they have a better connection.

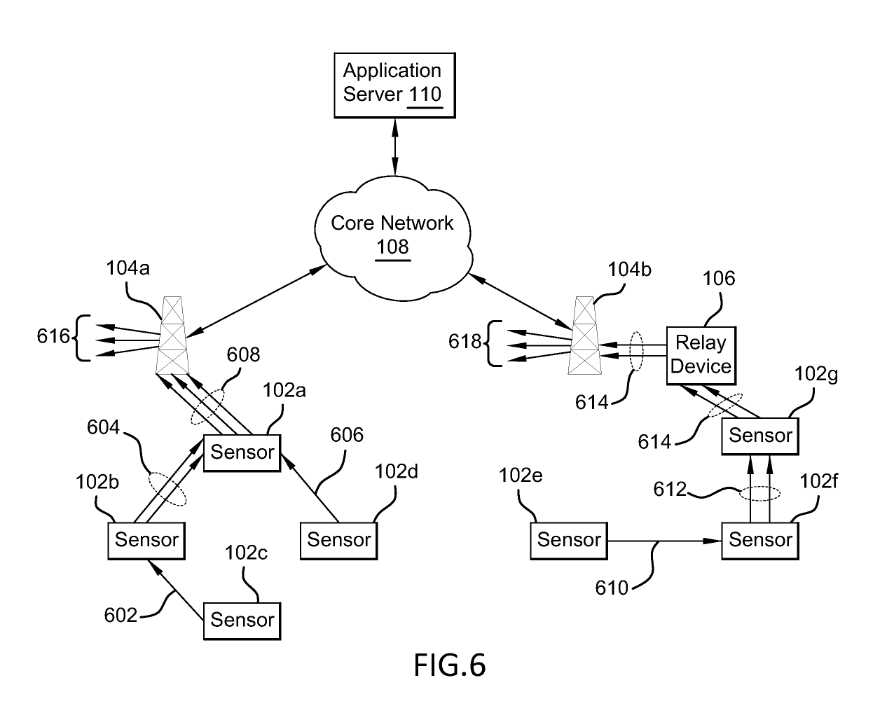

The multi-hop forwarding scheme, once triggered by the sensor device-initiated broadcast, is illustrated in FIG. 6, which is a block diagram of communications between devices in an exemplary wireless communications environment 100 according to embodiments of the present disclosure.

Discussion will focus first on the relationship between the base station 104a and the sensor devices 102a-102d. A plurality of time slots may be allocated specifically for D2D communications between the sensor devices 102a-102d. Each sensor device 102 from among 102a-102d may select its own time slot or be assigned the time slot by the base station 104a in which to transmit its own data message on to another sensor device 102 (for forwarding on to the gateway sensor device 102a of FIG. 6). The time slot selection scheme may follow a deterministic or a random algorithm. Each data message may have one or more of its own message-specific ID, a separate identifier for the message originator, an authenticator for verification by peer sensor devices 102, a hop count, and/or a time stamp that may reveal information about the expiry of the data message.

When the sensor devices 102b-102d each have their own time slot, they transmit their data messages. In an embodiment, the same set of timeslots which the sensor devices 102 used in rebroadcasting the gateway announcement may be used for forwarding data messages. Alternatively, a separate set of time slots may be allocated by the base station 104a or selected amongst the sensor devices 102. Using FIG. 6 as just one exemplary illustration, sensor device 102c may transmit its data message 602 to sensor device 102b, such as by a D2D link between the sensor device 102c and sensor device 102b. This may be due, for example, to a routing table entry kept at the sensor device 102c directing it to send its data to sensor device 102b instead of sensor device 102d, although both routes would provide a path to the gateway sensor device 102a. Further, the sensor device 102c may have updated its routing table to reflect a reverse path back to the gateway sensor device 102a generated in response to the multi-hop rebroadcasting scheme used to broadcast the identification of the sensor device 102a as a gateway. The routing table entry may have been further generated based on a route that would reduce overhead. This may be accomplished by including a specific address in the data message 602 so that any other sensor devices, such as sensor device 102d, will know to ignore or discard the message. Alternatively, the sensor device 102c may broadcast its data message 602 to any sensor device 102 within D2D communication with it, for example both sensor devices 102b and 102d in FIG. 6. The sensor device 102c may construct routes over time by learning after the broadcast which routes were successful in reaching the base station 104a and which routes were not.

Upon receiving the data message 602 from the sensor device 102c, the sensor device 102b may apply a filter function to determine whether the data message 602 should be dropped, for example by the forwarding module 210 illustrated in FIG. 2. For example, the filter function may first include analyzing the authenticator where that is included in the data message 602. Where a hop count is included, the sensor device 102b may additionally compare the hop count of the data message 602 to a max hop count value, for example that was set previously. If the hop count exceeds the max hop count value, the sensor device 102b may drop the data message 602. If the hop count is less than the max hop count value, the sensor device 102b may continue with forwarding on the data message 602.

To do so, the sensor device 102b may consult a routing table for an entry of the gateway ID (e.g., in this example of sensor device 102a) that was included with the broadcast 506. In an embodiment, the routing table may be a reverse path routing table that reflects the path used to broadcast the gateway announcement as cached by the sensor device 102b. If there is no such entry in a routing table of the sensor device 102b, the sensor device 102b may drop the data message 602. If the entry exists, the sensor device 102b may rebroadcast the data message 602 according to the routing table entry. As part of rebroadcasting, the sensor device 102b may select one of the plurality of time slots allocated for D2D communications to use for rebroadcasting the data message 602 as part of data message 604. In an embodiment, the sensor device 102b may have its own data message to transmit. The sensor device 102b may have transmitted its own data message previously, or may combine it with the data message 602 (and any other data messages from other neighbors as the case may be) and broadcast the combination as data message 604 toward the gateway, sensor device 102a. If the data message 602 included a hop count, the sensor device 102b may increment the hop count before sending the data message 604.

During the allocated time slots for D2D communications, the gateway sensor device 102a listens for broadcasts from neighboring sensor devices 102, such as sensor devices 102b and 102d in the example of FIG. 6. When the gateway sensor device 102a receives the data message 604 from the sensor device 102b, the gateway sensor device 102a may also apply a filter function, as described above regarding sensor device 102b. If the data message 604 passes the filtering function, the gateway sensor device 102a may forward the data message as part of data message 608 to the base station 104a. The data message 608 may also include data from the data message 606 forwarded from the sensor device 102d, in much the same manner as discussed above with respect to sensor devices 102c and 102b. Although shown as being transmitted together as part of a single data message 608 from the gateway sensor device 102a, it will be recognized that the data messages received from the different sensor devices 102b, 102c, and 102d may be received during different time slots and/or forwarded to the base station in different time slots.

In similar fashion, the sensor device 102d may transmit its data message 606 to sensor device 102a, for example by a D2D link between sensor devices 102d and 102a. This may occur, for example, during one of the time slots allocated for D2D communications, either at a same time as the data message 602 from sensor device 102c or another time. The sensor device 102a, which in FIG. 6 has been designated as the gateway sensor device, may similarly filter the data message 606 when it is received from sensor device 102d. If the data message 606 passes the filter function, the gateway sensor device 102a may forward the data message as part of the data message 608, either together with the data messages 602 and/or 604 or separately, e.g. during different time slots.

When the base station 104a receives a forwarded data message 608 from the gateway sensor device 102a, the base station may also apply a filter function, such as authentication, before forwarding on the data message 608, e.g. via the core network 108 to the application server 110 for storage/analysis/etc.

A similar procedure may occur for data messages from sensor devices 102e and 102f in the example of FIG. 6, albeit with sensor device 102g as the gateway. For example, when sensor device 102e has data to send, it takes a selected time slot as described above and sends a data message 610 to a neighboring sensor device, for example sensor device 102f as shown in FIG. 6. The sensor device 102f may apply a filter function as described above, and if the data message 610 is not discarded, the sensor device 102f may rebroadcast the data message as data message 612, which may be alone or in combination with a data message originating from the sensor device 102f. The sensor device 102g, acting as a gateway, listens for broadcasts from neighboring sensor devices 102e and 102f in the example of FIG. 6. When the gateway sensor device 102g receives the data message 612 from the sensor device 102f, the gateway sensor device 102g may also apply a filter function. If the data message 612 is not dropped, the sensor device 102g may forward the data message 612 as part of the data message 614 via the relay device 106 to the base station 104b. The base station 104b, upon receiving the data message 614, may also apply a filter function and, if not dropped, forward the data message 614 alone or aggregated with other data messages via the core network 108 to the application server 110.

The base stations 104 may broadcast confirmation messages to any sensor devices 102 within downlink range. For example, base station 104a may broadcast confirmation message 616 and base station 104b may broadcast confirmation message 618, each listing message IDs for those they successfully received. Each sensor device 102 listens for this broadcast, for example at a separate time slot set aside for such broadcasts. In an embodiment, those sensor devices 102 that have not been selected as gateways may be the ones to listen for this broadcast. In an alternative embodiment, the base stations 104 may send the confirmation message 618 via the gateway sensor devices 102 to the sensor devices 102, e.g. via the same multi-hop rebroadcasting path used previously by the gateway. In the above manner, even sensor devices 102 that do not have uplinks to any base station 104 may still be able to convey their data periodically, e.g. as synchronized with a base station beacon, to a remote server.

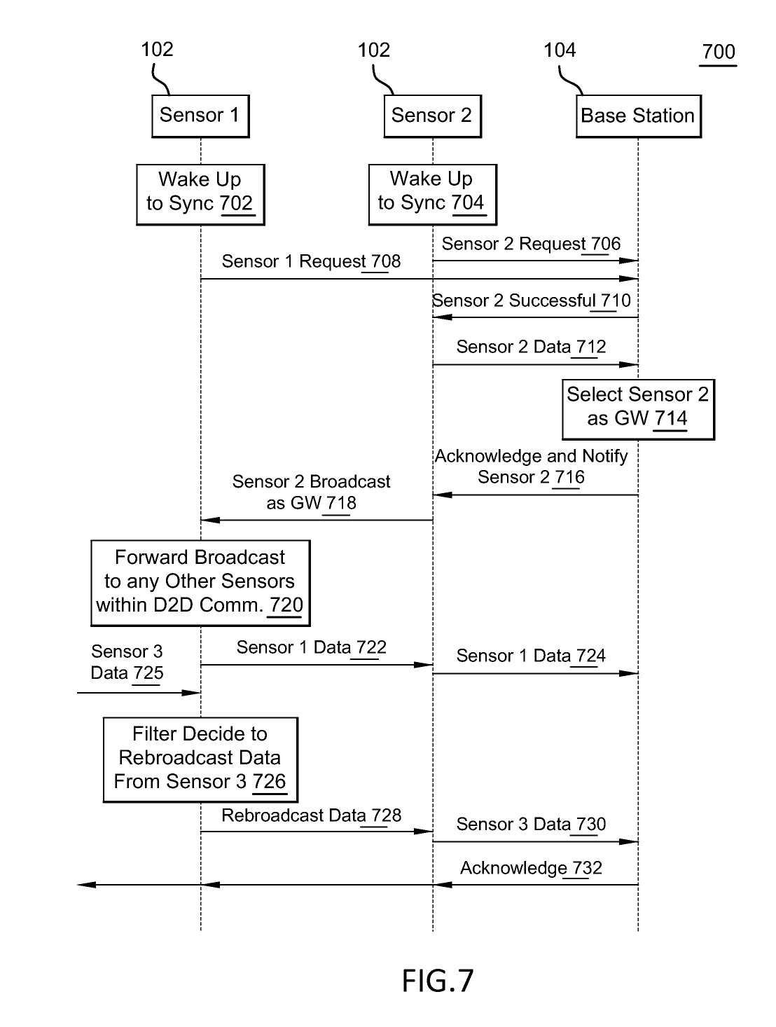

FIG. 7 is a protocol diagram 700 that illustrates example transmissions according to embodiments of the present disclosure. In FIG. 7, two sensor devices, sensors 1 and 2, within the same coverage area of a single base station are illustrated for purposes of simplicity. Sensors 1 and 2 may represent sensor devices 102, and the base station may represent a base station 104 from FIG. 1. It will be understood that more sensor devices and/or base stations may be involved. The sensor 1 wakes up to synchronize 702 with a base station beacon. Sensor 2 also wakes up to synchronize 704 with the base station beacon. In an embodiment, sensor 1 and sensor 2 have previously established D2D links with each other that will be used later.

Upon synchronizing to the beacon, the sensors 1 and 2 may continue their operations within a set of time slots allocated for the wake-up period. The sensor 1 may send a connection request 708 and the sensor 2 may send a connection request 706 to the base station. This may occur during a particular time slot(s) of the allocated set, for example. The attempts, as exhibited by the connection requests 706 and 708, may include both attempts to connect directly to the base station (a direct uplink) and/or broadcasting of a discovery signal for any possible relay devices 106 as described with respect to FIG. 4 above to establish an uplink to the base station.

In the example of FIG. 7, the sensor 2 is the only sensor to successfully establish an uplink connection, whether directly or opportunistically via a relay device 106. The base station sends a message 710 to sensor 2 indicating the connection request was successful. In response, the sensor 2 sends a data message 712 to the base station to be conveyed to a remote destination. In an embodiment, the sensor 2 may additionally send link quality and other information with or separate from the data message 712 to the base station.

The base station may use this information in determining whether to select the sensor 2 as a gateway for other sensors that cannot establish an uplink to the base station, such as sensor 1 in the example of FIG. 7. After analyzing the available information, in the example of FIG. 7 the base station selects (714) sensor 2 to function as a gateway. The base station lets the sensor 2 know of its selection by sending a gateway notice 716 to the sensor 2. The sensor 2, in turn, broadcasts this information as gateway notice 718 to its peer devices, for example by way of a multi-hop rebroadcasting scheme. The gateway notice 718 may include an ID of the sensor 2 that other sensors will use to route their messages appropriately. Sensor 1, as well as any other sensors within range that are not shown in FIG. 7, receives this broadcast in turn and rebroadcasts it (720) to any other peer sensor devices 102, which can trigger a multi-hop forwarding scheme according to embodiments of the present disclosure.

Once sensor 1 knows that sensor 2 is functioning as a gateway to the base station, sensor 1 sends its own data 722 to its neighbor, sensor 2, which has also been identified as the gateway. Sensor 1 may send the data 722 to the sensor 2 via the D2D link between the two sensor devices during a time slot allocated for D2D communications. When sensor 2 receives the data 722, it may apply a filter function and drop the data 722 if anything does not pass the filter, e.g. an authenticator, hop count, or time stamp to name a few examples. If the data 722 passes the filter function, the sensor 2 may forward the data 722 as data 724 to the base station for relay on to a remote server, such as application server 110 of FIG. 1.

If there are other sensor devices within downlink range of the base station, for example a sensor 3 that is a neighbor to sensor 1, sensor 3 may send its data 725 to the neighboring sensor 1. The sensor 1 receives the data 725 from sensor 3 and can apply a filter function, for example as described above with respect to sensor 2 to decide whether to drop or rebroadcast the data (726). In an embodiment, the sensor 1 may first check a routing table for an entry of the gateway ID, here that of sensor 2. If no ID is found, the sensor 1 may drop the data. If the data from sensor 3 passes the filter function, the sensor 1 may rebroadcast the data 728 to the sensor 2, the next hop in the D2D chain. Sensor 2 may also apply a filter function, as described above, and if data 728 passes the filter function sensor 2 may forward the data 728 as data 730 to the base station, either alone or aggregated with rebroadcasted data from one or more other sensors.

In response to receiving these data messages, the base station may broadcast an acknowledgment 732 that lists identifiers of the messages that it has received. This may be done, for example, during a separate time slot that has been reserved so that the sensors not selected as gateways may know to listen for acknowledgment at the appropriate time slot. This acknowledgment may be sent on a rolling basis, e.g. in several different time slots through the wake-up period of the sensors, or at one set time in a wake-up period for all different messages received. The base station may also apply a filter function to messages received and, if passed, forward the data on via the core network 108 to the application server 110.

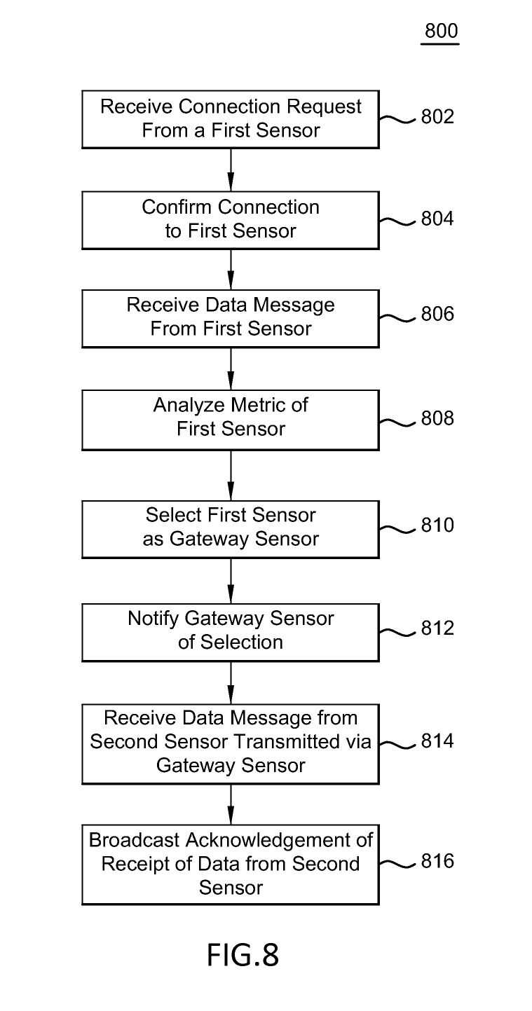

FIG. 8 is a flowchart illustrating an exemplary method 800 for receiving data messages via sensor-triggered forwarding according to embodiments of the present disclosure. In an embodiment, method 800 illustrates the reception of data messages at a base station 104 from one or more sensor devices 102, whether via direct uplink or via a relay device 106. Method 800 begins after a beacon has already been transmitted and sensor devices 102 have woken up for a wake-up period.

At step 802, the base station 104 receives a connection request from a first sensor device 102. Although other sensor devices 102 send connection requests as well, in the example of FIG. 8 only the first sensor device 102 is in sufficient proximity to be successful.

At step 804, the base station 104 confirms the connection with the first sensor device 102, for example, by transmitting a confirmation to the first sensor device 102.

At step 806, the base station receives a data message from the first sensor device 102 that originated with the first sensor device 102. In an embodiment, the data message is sent separate from the connection request. Alternatively, the connection request initially sent may include the data message. Additionally, the data message may include one or more metrics of the successful connection of the first sensor device 102 to determine whether to select it as a gateway. Some examples of metrics include link quality and information connectivity to other sensor devices 102 via D2D links, to name just a couple.

At step 808, the base station 104 analyzes the metric received from the first sensor device 102 to determine whether to select the first sensor device 102 as a gateway. For example, where there are multiple sensor devices 102 that were successful in connecting with a base station 104 and that have D2D links to one or more common sensor devices 102, the base station 104, for example by way of a gateway selection module, may analyze the link quality of each successful sensor device 102 and select a subset from those sensor devices 102, e.g. one or two or more, to function as gateways for other sensor devices 102. In the particular example of FIG. 8, since only the first sensor device 102 was successful in establishing an uplink, the base station's analysis focuses on whether the metric(s), such as link quality, is good enough for the first sensor device to operate as a gateway to other sensor devices 102.

At step 810, the base station selects the first sensor device 102 as a gateway. In an embodiment, even where the first sensor 102 was the only successful sensor device to establish an uplink, the base station 104 may not select it as a gateway. Should that occur, the sensors may wait for a subsequent wake up period to attempt connection again. In embodiments where multiple sensor devices 102 are successful in establishing uplinks, the base station may select the sensor device (or devices) that has the better metric, such as link quality.

At step 812, the base station 104 notifies the first sensor device 102 of its selection as a gateway. The first sensor device 102 may, in turn, broadcast its information as a gateway to the peer sensor devices 102 that it is connected with. Those peer sensor devices 102 in turn rebroadcast the gateway announcement for example by way of a multi-hop rebroadcasting scheme. This may be done, for example, at a specified time slot so that the sensor devices 102 may listen at the appropriate time to find out how they may still get data to the base station though an uplink was not possible. The information may be the unique ID of the first sensor 102 that the first sensor 102 uses in D2D communications with its neighbors.

At step 814, the base station 104 receives a data message from a second sensor device 102 that has been relayed via the first sensor device 102. The base station 104 may receive additional data messages from other sensor devices via the first sensor device 102 while it functions as a gateway for the duration of the wake-up period.

At step 816, the base station 104 broadcasts an acknowledgment of receipt of the data message from the second sensor device 102 (and any other sensor devices which transmitted data messages which the base station 104 received). The broadcast may list the message IDs of those that the base station 104 successfully received. This may occur in a separate time slot so that the sensor devices 102 are ready to listen for the broadcast.

The wake-up period may then end, and the above steps of method 800 repeated over a few or many wake-up periods. In an embodiment, the sensor devices 102 may “forget” which were selected as gateways in a prior wake-up period and attempt anew during each wake-up period. Alternatively, the sensor devices 102 may retain the knowledge of which were selected as gateways in a prior wake-up period and either forego attempting new uplinks with a base station 104 or re-confirm the uplink and gateway associations, in which case additional sensor devices 102 may become gateways in different wake-up periods and some may cease to be gateways, for example, where the uplink of a gateway sensor device 102 was via a relay device 106 that has since moved out of range to the sensor device and/or base station.

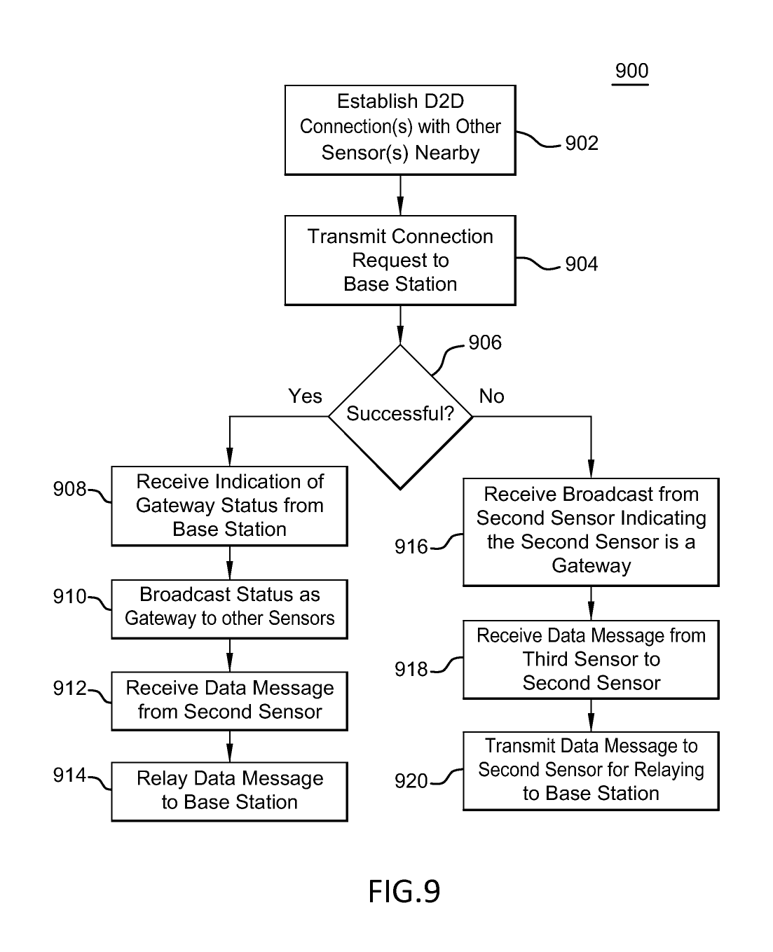

FIG. 9 is a flowchart illustrating an exemplary method 900 for sending data messages via sensor-triggered forwarding according to embodiments of the present disclosure. In an embodiment, method 900 begins after a beacon has already been transmitted and sensor devices 102 have woken up for a wake-up period. The method 900 may be, for example, a process from the perspective of any given sensor device 102 illustrated above in FIG. 1.

At step 902, the sensor device 102 establishes a D2D link with any other sensor devices 102 nearby. In an embodiment, the sensor device 102 may do so by sending out a discovery message to determine what other sensor devices 102 may be within a neighboring vicinity. The sensor device 102 may do so when first entering the environment 100, and/or periodically to detect whether other sensor devices have been added. Further, the sensor device 102 may respond to other sensor devices' requests to establish D2D links.

At step 904, the sensor device 102 transmits a connection request to a base station 104. This may include attempting to establish a direct link to the base station 104, or sending out discovery messages (or responding to such) for any relay device 106 that may be in sufficient vicinity, or some combination of the above.

If the sensor device 102 was selected as a gateway, the method 900 proceeds from decision 906 to step 908.

At step 908, the sensor device 102 receives a message from the base station 104 indicating that it has been selected as a gateway. Selection as a gateway indicates that the selected sensor device 102 was able to establish an uplink with the base station 104 and, in some embodiments, that the uplink was of sufficient quality to warrant selection as a gateway.

At step 910, the selected sensor device 102, operating as a gateway sensor device 102, broadcasts its information as a gateway to the peer sensor devices 102 that it is connected with. Those peer sensor devices 102 in turn rebroadcast the gateway announcement for example by way of a multi-hop rebroadcasting scheme.

At step 912, the gateway sensor device 102 receives a data message from a second sensor device 102 that is a neighbor to or otherwise in communication with the gateway sensor device 102. The data message may traverse, for example, a reverse path from the one the broadcast from the gateway sensor device 102 took to reach the second sensor device 102. The gateway sensor device 102 may filter the data message to determine whether to drop it or not.

At step 914, if the data message passes the filter the gateway sensor device 102 relays the data message on to the base station 104. This may occur with multiple data messages from multiple sensor devices 102, where some of the data messages reach the gateway sensor device 102 via a multi-hop scheme along D2D connections among the sensor devices 102.

If the sensor device 102 was not selected as a gateway, the method 900 proceeds from decision 906 to step 916.

At step 916, the non-selected sensor device 102 receives the broadcast announcement from another sensor device 102 that indicates another sensor device 102 is a gateway. The non-selected sensor device 102 may than rebroadcast this announcement to other peer sensor devices 102 by way of a multi-hop rebroadcasting scheme.

At step 918, the non-selected sensor device 102 may receive a data message from a third sensor device 102 that was not selected as a gateway. The non-selected sensor device 102 may filter the data message from the third sensor device 102 to determine whether to drop it or not.

If the data message passes the filter, at step 920 the non-selected sensor device 102 may forward the data message, alone or together with other data messages including its own, to the next hop toward the gateway sensor device 102, which could be the gateway sensor device 102 or an intervening sensor device 102. The non-selected sensor device 102 can transmit the data message(s) toward the gateway sensor device 102 identified in the broadcast at step 916 by checking a routing table for a route to the gateway sensor 102, for example a reverse path routing table that reflects the path used to broadcast the gateway announcement as cached by the non-selected sensor device 102. Alternatively, the non-selected sensor device 102 may broadcast the data message(s) towards the gateway sensor 102 so that any neighboring sensor device 102 may receive it for forwarding another hop toward the gateway sensor device 102.

The wake-up period may then end, and the above steps of method 900 repeated over a few or many wake-up periods, as described above with respect to FIG. 8.

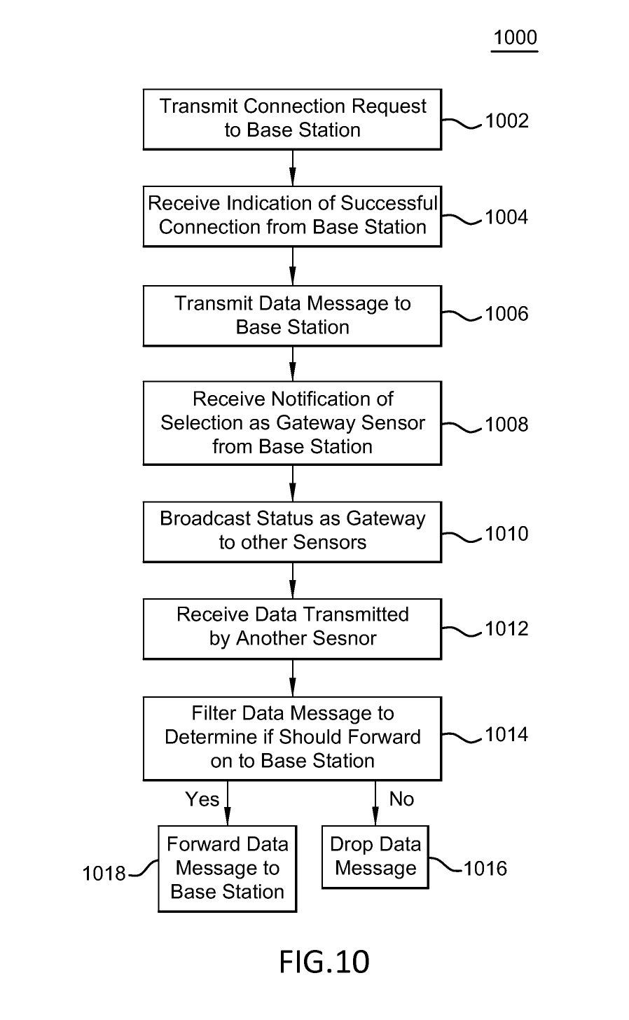

FIG. 10 is a flowchart illustrating an exemplary method 1000 for forwarding data messages via sensor-triggered forwarding according to embodiments of the present disclosure. In an embodiment, method 1000 begins after a beacon has already been transmitted and sensor devices 102 have woken up for a wake-up period. The method 1000 may be, for example, a process from the perspective of a sensor device 102 illustrated above in FIG. 1 that is able to establish an uplink, such as sensor devices 102a or 102g.

At step 1002, the sensor device 102 transmits a connection request to a base station 104. This may include attempting to establish a direct link to the base station 104, or sending out discovery messages (or responding to such) for any relay device 106 that may be in sufficient vicinity, or some combination of the above.

At step 1004, the sensor device 102 receives a confirmation from the base station 104 that the attempt of the sensor device 102 was successful.

At step 1006, the successful sensor device 102 sends its own data message to the base station 102.

At step 1008, the successful sensor device 102 receives an indication notification from the base station 104 that it has been selected as a gateway. This may be a message directed solely to the successful sensor device 102. Selection as a gateway indicates that the selected sensor device was able to establish an uplink with the base station 104 and, in some embodiments, that the uplink was of sufficient quality to warrant selection as a gateway.

At step 1010, the selected sensor device 102, operating as a gateway sensor device 102, broadcasts its information as a gateway to the peer sensor devices 102 that it is connected with. Those peer sensor devices 102 in turn rebroadcast the gateway announcement for example by way of a multi-hop rebroadcasting scheme.

At step 1012, the successful sensor device 102, now as a gateway sensor device 102, receives a data message from another sensor device 102.

At step 1014, the gateway sensor device 102 filters the data message to determine whether to drop it or not, as discussed above with respect to FIGS. 6 and 7.

If the gateway sensor device 102 determines, from the filtering, that the data message should be dropped, then the method 1000 proceeds to step 1016 and drops the data message. This may occur, for example, when the hop count exceeds a max hop count threshold, the data message could not be authenticated, a time stamp with the data message indicates that the data message has expired, or for some other relevant reason.

If the gateway sensor device 102 determines from the filtering that the data message should not be dropped and, rather, should be forwarded, then the method 1000 proceeds to step 1018 and forwards the data message to the base station 104.

The gateway sensor device 102 may listen for messages forwarded from neighboring sensor devices 102 via a multi-hop forwarding scheme for a specified duration of the wake-up period, for example during a set of time slots allocated for D2D communication between the sensor devices 102.

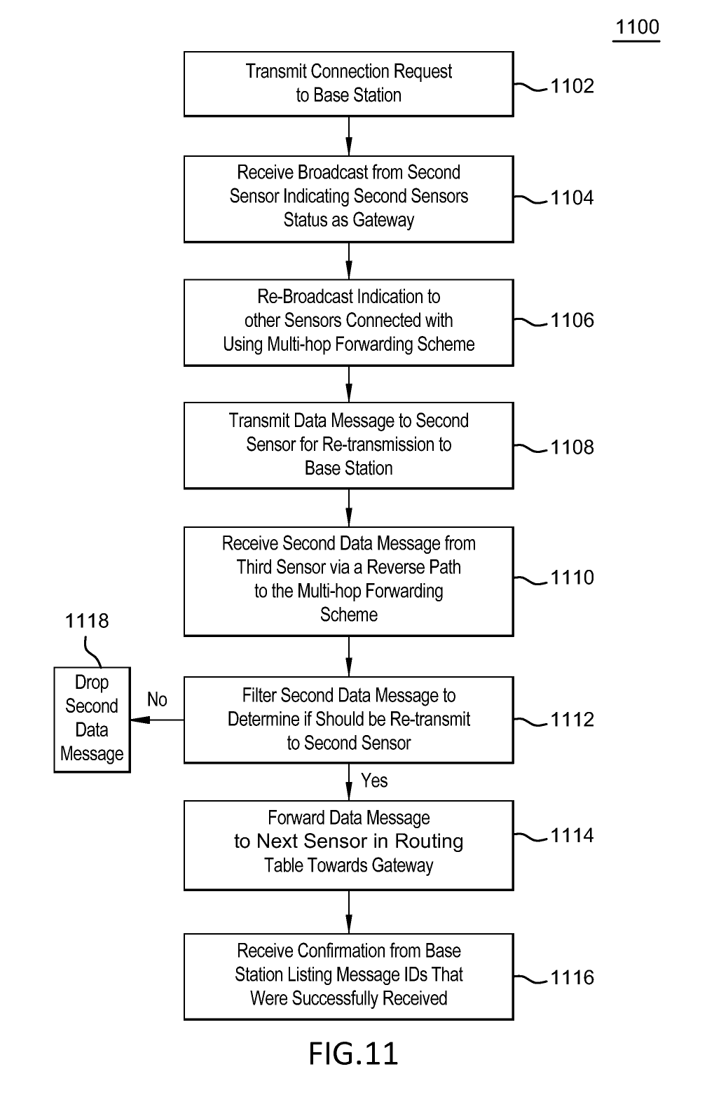

FIG. 11 is a flowchart illustrating an exemplary method 1100 for sending data messages via sensor-triggered forwarding according to embodiments of the present disclosure. In an embodiment, method 1100 begins after a beacon has already been transmitted and sensor devices 102 have woken up for a wake-up period. The method 1100 may be, for example, a process from the perspective of a sensor device 102 illustrated above in FIG. 1 that is not able to establish an uplink, such as any of sensor devices 102b-102f.

At step 1102, the sensor device 102 transmits a connection request to a base station 104. This may include attempting to establish a direct link to the base station 104, or sending out discovery messages (or responding to such) for any relay device 106 that may be in sufficient vicinity, or some combination of the above.

At step 1104, the sensor device 102 receives a broadcast from another peer sensor device 102 that identifies one or more other sensor devices 102 (e.g., sensor devices 102a or 102g in the example of FIGS. 5 and 6) have been selected as a gateway. In an embodiment where the sensor device 102 is neighbor to the gateway sensor device 102, the broadcast identifies the neighbor as the gateway sensor device 102. In another embodiment where the sensor device 102 is not neighbor to the gateway sensor device 102, the sensor device 102 receives the broadcast as a rebroadcast from another peer sensor device 102. Selection as a gateway indicates that the gateway sensor device 102 was able to establish an uplink with the base station 104 and, in some embodiments, that the uplink was of sufficient quality to warrant selection as a gateway.

At step 1106, the sensor device rebroadcasts the announcement that identifies the gateway sensor device 102. The sensor device 102 may rebroadcast this announcement to other peer sensor devices 102 by way of a multi-hop rebroadcasting scheme.

At step 1108, the sensor device 102 transmits its data message toward the gateway sensor device 102. The sensor device 102 may do so by first checking a routing table for a route to the gateway sensor 102, for example a reverse path routing table that reflects the path used to broadcast the gateway announcement as cached by the sensor device 102. Alternatively, the sensor device 102 may broadcast its data message towards the gateway sensor 102 so that any neighboring sensor device 102 may receive it for forwarding another hop.

At step 1110, the sensor device 102 receives a data message from another sensor device 102, for example a neighboring sensor device 102 that also was not selected as a gateway.

At step 1112, the sensor device 102 filters the data message from the other sensor device 102 to determine whether to drop it or not, for example as discussed above with respect to FIGS. 6 and 7.

If the sensor device 102 determines that the data message should be dropped, the method 1100 proceeds to step 1118 and drops the data packet. This may occur, for example, when the hop count exceeds a max hop count threshold, the data message could not be authenticated, a time stamp with the data message indicates that the data message has expired, or for some other relevant reason.

If the data message passes the filter at step 1112, the method 1100 proceeds to step 1114 where the sensor device 102 forwards the data message, alone or together with other data messages including its own, to the next hop toward the gateway sensor device 102. In this regard, steps 1108 and 1114 may be performed together or separately, including in any order when performed separately. As will be recognized, depending on the location of the sensor device 102 the next hop could be the gateway sensor device 102 or an intervening sensor device 102.

At step 1116, the sensor device 102, as well as some or all of the other sensor devices 102 that were not selected as gateways, receives a broadcast from the base station 104 that includes an acknowledgment of receipt of the data message(s) received during the allocated time slots. The broadcast may list the message IDs of those that the base station 104 successfully received. This may occur in a separate time slot so that the sensor devices 102 are ready to listen for the broadcast.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of” indicates an inclusive list such that, for example, a list of [at least one of A, B, or C] means A or B or C or AB or AC or BC or ABC (i.e., A and B and C).

Embodiments of the present disclosure include a method for communicating with a wireless network comprising receiving, at a first sensor, a signal from a second sensor indicating that the second sensor is a gateway to a base station in communication with the second sensor, wherein the signal is generated in response to the second sensor connecting with the base station; and transmitting, from the first sensor, a data packet to the second sensor such that the data packet is relayed to the base station via the second sensor.

The method further includes establishing a device to device (D2D) connection between the first sensor and the second sensor, wherein the transmitting further comprises transmitting the data packet to the second sensor via the D2D connection. The method further includes selecting, by the first sensor, a time slot for D2D communications from among a plurality of time slots allocated for D2D communications in order to transmit the data packet to the second sensor. The method further includes transmitting, from the first sensor, the signal to a third sensor using a multi-hop forwarding scheme. The method further includes receiving, at the first sensor, a second data packet from the third sensor via a reverse path of the multi-hop forwarding scheme. The method further includes receiving, at the first sensor, a beacon from the base station during a first time slot of the wake-up period; and synchronizing communications, by the first sensor, to the beacon. The method further includes wherein the signal from the second sensor is received during a second time slot of the wake-up period; and the data packet is transmitted to the second sensor during a third time slot of the wake-up period. The method further includes receiving, at the first sensor in a fourth time slot, an acknowledgment of receipt of the data packet from the base station. The method further includes receiving, at the first sensor, a data packet that is directed towards the base station from a third sensor; and transmitting, from the first sensor, the data packet from the third sensor to the second sensor. The method further includes looking up, at the first sensor and in response to receiving the data packet from the third sensor, a routing table entry corresponding to the second sensor, wherein the transmitting the data packet from the third sensor to the second sensor is based on the routing table entry.

Embodiments of the present disclosure further include a sensor apparatus comprising a sensor configured to generate data from a detected event; and a transceiver configured to receive a signal from a second sensor indicating that the second sensor is a gateway to a base station in communication with the second sensor, wherein the signal is generated in response to the second sensor connecting with the base station; and transmit a data packet to the second sensor such that the data packet is relayed to the base station via the second sensor.

The sensor apparatus further includes wherein the transceiver is further configured to establish a device to device (D2D) connection between the sensor apparatus and the second sensor, wherein the transmitting further comprises transmitting the data packet to the second sensor via the D2D connection. The sensor apparatus further includes a processor configured to select a time slot for D2D communications from among a plurality of time slots allocated for D2D communications in order to transmit the data packet to the second sensor. The sensor apparatus further includes wherein the transceiver is further configured to transmit the signal to a third sensor using a multi-hop forwarding scheme. The sensor apparatus further includes wherein the transceiver is further configured to receive a second data packet from the third sensor via a reverse path of the multi-hop forwarding scheme. The sensor apparatus further includes wherein the transceiver is further configured to receive a beacon from the base station, and the sensor apparatus further comprises a processor configured to synchronize communications to the beacon. The sensor apparatus further includes wherein the signal from the second sensor is received during a second time slot of the wake-up period and the data packet is transmitted to the second sensor during a third time slot of the wake-up period. The sensor apparatus further includes wherein the transceiver is further configured to receive, in a fourth time slot, an acknowledgment of receipt of the data packet from the base station. The sensor apparatus further includes wherein the transceiver is further configured to receive a data packet that is directed towards the base station from a third sensor and transmit the data packet that is from the third sensor to the second sensor. The sensor apparatus further includes a memory comprising a routing table and a processor configured to look up, in the memory and in response to receiving the data packet from the third sensor, a routing table entry corresponding to the second sensor in the routing table, wherein the data packet is transmitted from the third sensor to the second sensor based on the routing table entry.

Embodiments of the present disclosure further include a computer-readable medium having program code recorded thereon, the program code comprising code for causing a computer to transmit a connection request to a base station; code for causing the computer to receive a message from the base station indicating that the computer is a gateway to the base station; code for causing the computer to transmit, to a second sensor in communication with the computer, a signal indicating that the computer is the gateway; and code for causing the computer to relay a data packet from the second sensor to the base station.

The computer-readable medium further includes code for causing the computer to establish a device to device (D2D) connection between the computer and the second sensor. The computer-readable medium further includes code for causing the computer to receive, from the second sensor via the D2D connection, the data packet; and code for causing the computer to transmit the data packet to the base station. The computer-readable medium further includes code for causing the computer to transmit the signal to a plurality of sensors using a multi-hop forwarding scheme. The computer-readable medium further includes code for causing the computer to receive, from a third sensor, a second data packet via a reverse path of the multi-hop forwarding scheme. The computer-readable medium further includes code for causing the computer to receive a beacon from the base station; and code for causing the computer to synchronize communications to the beacon. The computer-readable medium further includes wherein the connection request is transmitted during a first time slot of a wake-up period established by the beacon; the broadcast is received during a second time slot of the wake-up period; and the data packet is transmitted during a third time slot of the wake-up period. The computer-readable medium further includes code for causing the computer to broadcast a discovery signal to a user equipment (UE) in a vicinity of the computer; code for causing the computer to establish a connection with a UE that responds to the discovery signal; and code for causing the computer to transmit the connection request to the base station via the UE, the UE operating as a relay between the base station and the computer.

Embodiments of the present disclosure further include a computer-readable medium having program code recorded thereon, the program code comprising code for causing a computer to receive a signal from a second sensor indicating that the second sensor is a gateway to a base station in communication with the second sensor, wherein the signal is generated in response to the second sensor connecting with the base station; and code for causing the computer to transmit a data packet to the second sensor such that the data packet is relayed to the base station via the second sensor.

The computer-readable medium further includes code for causing the computer to establish a device to device (D2D) connection between the computer and the second sensor, wherein the transmitting further comprises transmitting the data packet to the second sensor via the D2D connection. The computer-readable medium further includes code for causing the computer to select a time slot for D2D communications from among a plurality of time slots allocated for D2D communications in order to transmit the data packet to the second sensor. The computer-readable medium further includes code for causing the computer to transmit the signal to a third sensor using a multi-hop forwarding scheme. The computer-readable medium further includes code for causing the computer to receive a second data packet from the third sensor via a reverse path of the multi-hop forwarding scheme. The computer-readable medium further includes code for causing the computer to receive a beacon from the base station; and code for causing the computer to synchronize communications to the beacon. The computer-readable medium further includes wherein the signal from the second sensor is received during a second time slot of the wake-up period; and the data packet is transmitted to the second sensor during a third time slot of the wake-up period. The computer-readable medium further includes code for causing the computer to receive a data packet that is directed towards the base station from a third sensor; and code for causing the computer to transmit the data packet from the third sensor to the second sensor. The computer-readable medium further includes code for causing the computer to look up, in response to receiving the data packet from the third sensor, a routing table entry corresponding to the second sensor, wherein the transmitting the data packet from the third sensor to the second sensor is based on the routing table entry.

Embodiments of the present disclosure further include a computer-readable medium having program code recorded thereon, the program code comprising code for causing a computer to receive a connection request from a first sensor; code for causing the computer to assign the first sensor as a gateway in response to receiving the connection request; code for causing the computer to transmit a message indicating that the first sensor is the gateway to the first sensor, wherein the first sensor broadcasts information to a second sensor in communication with the first sensor that indicates the first sensor is the gateway; and code for causing the computer to receive a data packet from the second sensor, wherein the data packet from the second sensor is relayed to the computer via the first sensor.

The computer-readable medium further includes code for causing the computer to receive a connection request from a third sensor; code for causing the computer to analyze a first link quality associated with the connection request from the first sensor and a second link quality associated with the connection request from the third sensor; and code for causing the computer to select the first sensor or the third sensor as the gateway based on a comparison of the first link quality to the second link quality. The computer-readable medium further includes code for causing the computer to receive the first link quality from the first sensor; and code for causing the computer to receive the second link quality from the third sensor. The computer-readable medium further includes code for causing the computer to receive a second data packet from a third sensor, wherein the second data packet is relayed to the computer via the first sensor and the second sensor via a reverse path of a multi-hop forwarding scheme used by the first sensor to broadcast the information that the first sensor is the gateway. The computer-readable medium further includes code for causing the computer to transmit a beacon to the first and the second sensors. The computer-readable medium further includes wherein the connection request is received at the base station during a first time slot of a wake-up period synchronized to the beacon; the message is transmitted during a second time slot of the wake-up period; and the data packet from the second sensor is received during a third time slot of the wake-up period. The computer-readable medium further includes code for causing the computer to receive the connection request from a user equipment (UE) that operates as a relay between the base station and the first sensor.

Embodiments of the present disclosure further include a sensor apparatus comprising means for transmitting a connection request to a base station; means for receiving a message from the base station indicating that the sensor apparatus is a gateway to the base station; means for transmitting a signal indicating that the sensor apparatus is the gateway to a second sensor in communication with the sensor apparatus; and means for relaying a data packet from the second sensor to the base station.

The sensor apparatus further includes means for establishing a device to device (D2D) connection between the sensor apparatus and the second sensor. The sensor apparatus further includes means for receiving the data packet via the D2D connection and transmitting the data packet to the base station. The sensor apparatus further includes means for transmitting the signal to a plurality of sensors using a multi-hop forwarding scheme. The sensor apparatus further includes means for receiving, from a third sensor, a second data packet via a reverse path of the multi-hop forwarding scheme.

Embodiments of the present disclosure further include a sensor apparatus comprising means for generated data from a detected event; means for receiving a signal from a second sensor indicating that the second sensor is a gateway to a base station in communication with the second sensor, wherein the signal is generated in response to the second sensor connecting with the base station; and means for transmitting a data packet that encapsulates the generated data to the second sensor such that the data packet is relayed to the base station via the second sensor.

The sensor apparatus further includes means for establishing a device to device (D2D) connection between the sensor apparatus and the second sensor, wherein the transmitting further comprises transmitting the data packet to the second sensor via the D2D connection. The sensor apparatus further includes means for selecting a time slot for D2D communications from among a plurality of time slots allocated for D2D communications in order to transmit the data packet to the second sensor. The sensor apparatus further includes means for transmitting the signal to a third sensor using a multi-hop forwarding scheme. The sensor apparatus further includes means for receiving a second data packet from the third sensor via a reverse path of the multi-hop forwarding scheme. The sensor apparatus further includes means for receiving a data packet that is directed towards the base station from a third sensor; and means for transmitting the data packet that is from the third sensor to the second sensor. The sensor apparatus further includes means for looking up, in response to receiving the data packet from the third sensor, a routing table entry corresponding to the second sensor, wherein the data packet is transmitted from the third sensor to the second sensor based on the routing table entry.

Embodiments of the present disclosure further include a base station for wireless communication comprising means for receiving a connection request from a first sensor; means for assigning the first sensor as a gateway in response to receiving the connection request; means for transmitting a message indicating that the first sensor is the gateway to the first sensor, wherein the first sensor broadcasts information to a second sensor in communication with the first sensor that indicates the first sensor is the gateway; and means for receiving a data packet from the second sensor, wherein the data packet from the second sensor is relayed to the base station via the first sensor.

The base station further includes means for receiving a connection request from a third sensor; means for analyzing a first link quality associated with the connection request from the first sensor and a second link quality associated with the connection request from the third sensor; and means for selecting the first sensor or the third sensor as the gateway based on a comparison of the first link quality to the second link quality. The base station further includes means for receiving a second data packet from a third sensor, wherein the second data packet is relayed to the base station via the first sensor and the second sensor via a reverse path of a multi-hop forwarding scheme used by the first sensor to broadcast the information that the first sensor is the gateway.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method for communicating with a wireless network, comprising:
transmitting, from a first sensor, a connection request to a base station;
receiving, at the first sensor, a message from the base station indicating that the first sensor is a gateway to the base station;
transmitting, from the first sensor to a second sensor in communication with the first sensor, a signal indicating that the first sensor is the gateway; and
relaying, via the first sensor, a data packet from the second sensor to the base station.

2. The method of claim 1, further comprising:
establishing a device to device (D2D) connection between the first sensor and the second sensor;
receiving, from the second sensor via the D2D connection, the data packet; and
transmitting, from the first sensor, the data packet to the base station.

3. The method of claim 1, wherein the transmitting the signal includes:
transmitting, from the first sensor, the signal to a plurality of sensors using a multi-hop forwarding scheme.

4. The method of claim 3, further comprising:
receiving, at the first sensor from a third sensor, a second data packet via a reverse path of the multi-hop forwarding scheme.

5. The method of claim 1, further comprising:
receiving, at the first sensor, a beacon from the base station during a first time slot of a wake-up period;
synchronizing communications, by the first sensor, to the beacon;
wherein:
the connection request is transmitted during a second time slot of the wake-up period established by the beacon;
the broadcast is received during a third time slot of the wake-up period; and
the data packet is transmitted during a fourth time slot of the wake-up period.

6. The method of claim 5, further comprising:
receiving, in a fifth time slot, an acknowledgment of receipt of the data packet from the base station.

7. The method of claim 1, wherein the transmitting the connection request includes:
broadcasting, from the first sensor, a discovery signal to a user equipment (UE) in a vicinity of the first sensor;
establishing, by the first sensor, a connection with a UE that responds to the discovery signal; and
transmitting, from the first sensor, the connection request to the base station via the UE, the UE operating as a relay between the base station and the first sensor.

8. The method of claim 1, further comprising:
receiving, at the first sensor during a subsequent wake-up period, a subsequent broadcast from a third sensor indicating that the third sensor is the gateway to the base station for the first and second sensors, wherein the first and second sensors are in communication with the third sensor; and
transmitting, from the first sensor, a subsequent data packet to the third sensor such that the subsequent data packet is relayed to the base station via the third sensor during the subsequent wake-up period.

9. A method for communicating with a wireless network, comprising:
receiving, at a base station, a connection request from a first sensor;
assigning, by the base station, the first sensor as a gateway in response to receiving the connection request;
transmitting, from the base station, a message to the first sensor indicating that the first sensor is the gateway, wherein the first sensor broadcasts information to a second sensor in communication with the first sensor that indicates the first sensor is the gateway; and
receiving, at the base station, a data packet from the second sensor, wherein the data packet from the second sensor is relayed to the base station via the first sensor.

10. The method of claim 9, wherein the assigning further comprises:
receiving, at the base station, a connection request from a third sensor;
analyzing, by the base station, a first link quality associated with the connection request from the first sensor and a second link quality associated with the connection request from the third sensor; and
selecting, by the base station, the first sensor or the third sensor as the gateway based on a comparison of the first link quality to the second link quality.

11. The method of claim 10, further comprising:
receiving, at the base station, the first link quality from the first sensor; and
receiving, at the base station, the second link quality from the third sensor.

12. The method of claim 9, further comprising:
receiving, at the base station, a second data packet from a third sensor,
wherein the second data packet is relayed to the base station via the first sensor and the second sensor via a reverse path of a multi-hop forwarding scheme used by the first sensor to broadcast the information that the first sensor is the gateway.

13. The method of claim 9, further comprising:
transmitting, from the base station, a beacon to the first and the second sensors, wherein the first and second sensors synchronize communications based on the beacon.

14. The method of claim 13, wherein:
the connection request is received at the base station during a first time slot of a wake-up period synchronized to the beacon;
the message is transmitted during a second time slot of the wake-up period; and
the data packet from the second sensor is received during a third time slot of the wake-up period, the method further comprising:
broadcasting, from the base station in a fourth time slot, an acknowledgment of receipt of the data packet.

15. The method of claim 9, wherein the receiving the connection request includes:
receiving, at the base station, the connection request from a user equipment (UE) that operates as a relay between the base station and the first sensor.

16. The method of claim 9, further comprising:
receiving, at the base station, a subsequent connection request from a third sensor in a subsequent wake-up period;
assigning, by the base station, the third sensor as the gateway during the subsequent wake-up period;
transmitting, from the base station, a subsequent message to the third sensor indicating that the third sensor is the gateway to a plurality of sensors including the first, second, and third sensors, wherein the third sensor broadcasts information to the first and second sensors in communication with the third sensor that indicates that the third sensor is the gateway; and
receiving, at the base station, a subsequent data packet from the first sensor, wherein the subsequent data packet from the first sensor is relayed to the base station via the third sensor during the subsequent wake-up period.

17. A sensor apparatus, comprising:
a sensor configured to generate data from a detected event;
a transceiver configured to:
transmit a connection request to a base station;
receive a message from the base station indicating that the sensor apparatus is a gateway to the base station; and
transmit a signal indicating that the sensor apparatus is the gateway to a second sensor in communication with the sensor apparatus; and
a forwarding module executed by a processor and configured to cause the transceiver to relay a data packet from the second sensor to the base station.

18. The sensor apparatus of claim 17, wherein the transceiver is further configured to establish a device to device (D2D) connection between the sensor apparatus and the second sensor and receive the data packet from the second sensor via the D2D connection and transmit the data packet to the base station.

19. The sensor apparatus of claim 17, wherein the transceiver is further configured to:
transmit the signal to a plurality of sensors using a multi-hop forwarding scheme; and
receive, from a third sensor, a second data packet via a reverse path of the multi-hop forwarding scheme.

20. The sensor apparatus of claim 17, wherein:
the transceiver is further configured to receive a beacon from the base station during a first time slot of a wake-up period;
the processor is further configured to synchronize communications to the beacon, wherein the connection request is transmitted during a second time slot of the wake-up period established by the beacon, the broadcast is received during a third time slot of the wake-up period, and the data packet is transmitted during a fourth time slot of the wake-up period; and
the transceiver is further configured to receive, in a fifth time slot, an acknowledgment of receipt of the data packet from the base station.

21. The sensor apparatus of claim 17, wherein the transceiver is further configured to:
broadcast a discovery signal to a user equipment (UE) in a vicinity of the sensor apparatus;
establish a connection with a UE that responds to the discovery signal; and
transmit the connection request to the base station via the UE, the UE operating as a relay between the base station and the sensor apparatus.

22. The sensor apparatus of claim 17, wherein the transceiver is further configured to:
receive, during a subsequent wake-up period, a subsequent broadcast from a third sensor indicating that the third sensor is the gateway to the base station for the first and second sensors, wherein the first and second sensors are in communication with the third sensor; and
transmit a subsequent data packet to the third sensor such that the subsequent data packet is relayed to the base station via the third sensor during the subsequent wake-up period.

23. A base station for wireless communication, comprising:
a transceiver configured to receive a connection request from a first sensor;
a processor configured to assign the first sensor as a gateway in response to receiving the connection request; and
the transceiver further configured to:
transmit a message indicating that the first sensor is the gateway to the first sensor, wherein the first sensor broadcasts information to a second sensor in communication with the first sensor that indicates the first sensor is the gateway; and
receive a data packet from the second sensor, wherein the data packet from the second sensor is relayed to the base station via the first sensor.

24. The base station of claim 23, wherein:
the transceiver is further configured to receive a connection request from a third sensor;
the processor is further configured to analyze a first link quality associated with the connection request from the first sensor and a second link quality associated with the connection request from the third sensor; and
the processor is further configured to select the first sensor or the third sensor as the gateway based on a comparison of the first link quality to the second link quality.

25. The base station of claim 24, wherein the transceiver is further configured to receive the first link quality from the first sensor and the second link quality from the third sensor.

26. The base station of claim 23, wherein:
the transceiver is further configured to receive a second data packet from a third sensor, and
the second data packet is relayed to the base station via the first sensor and the second sensor via a reverse path of a multi-hop forwarding scheme used by the first sensor to broadcast the information that the first sensor is the gateway.

27. The base station of claim 23, wherein the transceiver is further configured to transmit a beacon to the first and the second sensors.

28. The base station of claim 27, wherein:
the connection request is received at the base station during a first time slot of a wake-up period synchronized to the beacon;
the message is transmitted during a second time slot of the wake-up period;
the data packet from the second sensor is received during a third time slot of the wake-up period; and
the transceiver is further configured to broadcast, in a fourth time slot, an acknowledgment of receipt of the data packet.

29. The base station of claim 23, wherein the transceiver is further configured to receive the connection request from a user equipment (UE) that operates as a relay between the base station and the first sensor.

30. The base station of claim 23, wherein:
the transceiver is further configured to receive a subsequent connection request from a third sensor in a subsequent wake-up period;
the processor is further configured to assign the third sensor as the gateway during the subsequent wake-up period; and
the transceiver is further configured to transmit a subsequent message to the third sensor indicating that the third sensor is the gateway to a plurality of sensors including the first, second, and third sensors, wherein the third sensor broadcasts information to the first and second sensors in communication with the third sensor that indicates that the third sensor is the gateway, and receive a subsequent data packet from the first sensor,
wherein the subsequent data packet is relayed to the base station via the third sensor during the subsequent wake-up period.
